(19) United States
(12) Patent Application Publication
(10) Pub. No.: US 2026/0028489 A1
(43) Pub. Date: Jan. 29, 2026

(54) SUPPORTED POLYMERIZATION INHIBITORS AND THEIR USE IN CURABLE COMPOSITIONS FOR 3D PRINTING

(71) Applicant: Align Technology, Inc., San Jose, CA (US)

(72) Inventor: Umesh Upendra CHOUDHARY, Scotts Valley, CA (US)

(21) Appl. No.: 19/240,892

(22) Filed: Jun. 17, 2025

Related U.S. Application Data
(60) Provisional application No. 63/661,365, filed on Jun. 18, 2024.

(51) Int. Cl. C09D 7/65; A61C 7/08; B29C 64/314; B29K 105/00; B29L 31/00; B33Y 40/10; B33Y 70/00; B33Y 80/00; C08F 8/14; C08J 3/12; C08J 3/28; C09C 1/30; C09D 4/06; C09D 7/62; C09D 135/02

(52) U.S. Cl. CPC C09D 7/65; A61C 7/08; B29C 64/314; B33Y 40/10; B33Y 70/00; B33Y 80/00; C08F 8/14; C08J 3/128; C08J 3/28; C09C 1/3063; C09C 1/3081; C09C 1/309; C09D 4/06; C09D 7/62; C09D 135/02; B29K 2105/0044; B29K 2995/0077; B29L 2031/753; C08J 2325/06

(57) ABSTRACT

The present disclosure provides curable compositions comprising polymerization inhibitor-functionalized particles to prevent undesired polymerization of the polymerizable compounds in the curable compositions during their transportation, handling or storage, or during 3D printing processes. Such curable compositions can be used to produce polymeric materials with properties suitable for use in various 3D printed objects, such as orthodontic appliances.

### PRIORITY CLAIM AND CROSS-REFERENCE

This application claims the benefit of U.S. Provisional Patent Application No. 63/661,365, filed Jun. 18, 2024, which is incorporated by reference herein in its entirety.

### BACKGROUND

Additive manufacturing, also referred to as three-dimensional (3D) printing, has been widely used to fabricate orthodontic appliances out of photopolymerizable materials. Many additive manufacturing techniques involve successively adding layers of photopolymerizable materials and curing these layers by controlled light exposure. The photopolymerizable materials often include reactive components that are cured with light. Acrylate-based resins, which undergo free-radical polymerization, are the most commonly used photosensitive resins for additive manufacturing technologies due to their high photopolymerization curing speed.

### SUMMARY

Provided herein are particle-supported polymerization inhibitors for use in curable (i.e., polymerizable) resin compositions. These inhibitors help prevent premature and spontaneous polymerization of polymerizable components during various stages of additive manufacturing, as well as during handling, storage, and transport. The curable compositions have a range of applications, including in the additive manufacturing of metal devices such as orthodontic appliances. Also provided herein are 3D printed objects produced from the curable compositions, materials derived from the curable compositions, and methods of using the resulting 3D printed objects.

In one aspect, a surface functionalized particle is provided. The surface functionalized particle includes a particle having a surface and a plurality of polymerization inhibitor moieties covalently bonded to the surface of the particle.

In another aspect, a curable composition is provided. The composition includes a plurality of surface functionalized particles disclosed herein; a reactive diluent, wherein the reactive diluent is a polymerizable compound having a molecular weight of 0.1 to 1.0 kDa; and a telechelic compound comprising an oligomeric or a polymeric chain of interconnected monomeric units having a first terminal end and a second terminal end, wherein the oligomeric or polymeric chain is selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ether, (poly)ester, and (poly)urethane; at least one first reactive functional group covalently bonded to the first terminal end; and at least one second reactive functional group covalently bonded to the second terminal end.

In another aspect, a polymeric material formed from a curable composition disclosed herein is provided. In some embodiments, the polymeric material is characterized by one or more of: a stress relaxation of greater than or equal to 5% of the initial load; and a glass transition temperature of greater than or equal to 90° C. In some embodiments, the polymeric material is further characterized by one or more of: a tensile modulus greater than or equal to 100 MPa; a tensile strength at yield greater than or equal to 5 MPa; an elongation at yield greater than or equal to 4%; an elongation at break greater than or equal to 5%; a storage modulus greater than or equal to 300 MPa; and a stress relaxation greater than or equal to 0.01 MPa. In some embodiments, the polymeric material is characterized by a stress relaxation of 5% to 45% of the initial load. In some embodiments, the polymeric material is characterized by a stress relaxation of 20% to 45% of the initial load. In some embodiments, the polymeric material is characterized by a glass transition temperature of 90° C. to 150° C. In some embodiments, the polymeric material is characterized by a tensile modulus from 100 MPa to 2000 MPa. In some embodiments, the polymeric material is characterized by a tensile modulus from 800 MPa to 2000 MPa. In some embodiments, the polymeric material is characterized by a tensile strength at yield of 5 MPa to 85 MPa. In some embodiments, the polymeric material is characterized by a tensile strength at yield of 20 MPa to 55 MPa. In some embodiments, the polymeric material is characterized by a tensile strength at yield of 25 MPa to 55 MPa. In some embodiments, the polymeric material is characterized by an elongation at yield of 4% to 10%. In some embodiments, the polymeric material is characterized by an elongation at yield of 5% to 10%. In some embodiments, the polymeric material is characterized by an elongation at break of 5% to 250%. In some embodiments, the polymeric material is characterized by an elongation at break of 20% to 250%. In some embodiments, the polymeric material is characterized by a storage modulus of 300 MPa to 3000 MPa. In some embodiments, the polymeric material is characterized by a storage modulus of 750 MPa to 3000 MPa. In some embodiments, the polymeric material is characterized by a stress relaxation of 0.01 MPa to 15 MPa. In some embodiments, the polymeric material is characterized by a stress relaxation of 2 MPa to 15 MPa. In some embodiments, the polymeric material is characterized by: a stress relaxation of greater than or equal to 20% of the initial load; a glass transition temperature of greater than or equal to 27° C.; a tensile modulus from 800 MPa to 2000 MPa; and an elongation at break greater than or equal to 20%. In some embodiments, the polymeric material is biocompatible, bioinert, or a combination thereof.

In still another aspect, an orthodontic appliance comprising the polymeric material disclosed herein is provided. In some embodiments, the orthodontic appliance is an aligner, an expander, or a retainer. In some embodiments, the orthodontic appliance comprises a plurality of tooth receiving cavities configured to reposition teeth from a first configuration toward a second configuration. In some embodiments, the orthodontic appliance is one of a plurality of orthodontic aligners configured to reposition the teeth from an initial configuration toward a target configuration. In some embodiments, the orthodontic appliance is one of a plurality of aligners configured to reposition the teeth from an initial configuration toward a target configuration according to a treatment plan.

In still another aspect, a method of forming an orthodontic appliance is provided. The method includes providing a curable composition disclosed herein; removing the plurality of surface functionalized particles from the curable composition; curing the curable composition to form a polymeric material; and fabricating the orthodontic appliance with the polymeric material. In some embodiments, curing the curable composition comprises exposing the curable composition to a light source. In some embodiments, the light source is an ultraviolet light source. In some embodiments, the method further comprises heating the curable composition to a processing temperature. In some embodiments, the processing temperature is from about 50° C. to about 120° C. In some embodiments, the processing temperature is from about 90° C. to about 110° C., from about 100° C. to about 120° C., from about 105° C. to about 115° C., or from about 108° C. to about 110° C. In some embodiments, the method further comprises heating the polymeric material at an elevated temperature. In some embodiments, the elevated temperature is from 40° C. to 150° C. In some embodiments, heating the polymeric material to the elevated temperature occurs after curing the curable composition. In some embodiments, forming the orthodontic appliance comprises additive manufacturing. In some embodiments, forming the orthodontic appliance comprises printing the curable composition with a 3D printer. In some embodiments, printing the curable composition is performed using a high temperature lithography. In some embodiments, the orthodontic appliance is an aligner, an expander, or a retainer.

In still another aspect, a method of preparing a medical device by an additive manufacturing process is provided. The method includes providing a curable composition disclosed herein; removing the plurality of surface functionalized particles from the curable composition; after removing the plurality of surface functionalized particles, placing the curable composition in a 3D printer, wherein parts of the 3D printer that are exposed to the curable composition include surface functionalized particles; heating the curable composition in the 3D printer to a processing temperature; exposing the curable composition to radiation; polymerizing the curable composition layer-by-layer based on a predefined design, thereby forming a polymeric material; and fabricating the medical device with the polymeric material. In some embodiments, the processing temperature is from about 50° C. to about 120° C. In some embodiments, the additive manufacturing process is a 3D printing process. In some embodiments, the medical device is an orthodontic appliance.

In still another aspect, a method of repositioning a patient's teeth is provided. The method includes generating a treatment plan for a patient, the plan comprising a plurality of intermediate tooth arrangements for moving teeth along a treatment path from an initial arrangement toward a final arrangement; producing an orthodontic appliance; and moving on-track, with the orthodontic appliance, at least one of the patient's teeth toward an intermediate arrangement or a final tooth arrangement. In some embodiments, the method further comprises tracking progression of the patient's teeth along the treatment path after administration of the orthodontic appliance, the tracking comprising comparing a current arrangement of the patient's teeth to a planned arrangement of the teeth. In some embodiments, greater than 60% of the patient's teeth are on track with the treatment plan after 2 weeks of treatment. In some embodiments, the orthodontic appliance has a retained repositioning force to the at least one of the patient's teeth after 2 days that is at least 10%, at least 20%, at least 30%, at least 40%, at least 50%, at least 60%, or at least 70% of repositioning force initially provided to the at least one of the patient's teeth. In some embodiments, the method further comprises achieving on-track the movement of the at least one of the patient's teeth to the intermediate arrangement or the final tooth arrangement. In some embodiments, prior to moving on-track, with the orthodontic appliance, the at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

In yet another aspect, a method for preparing a surface functionalized particle comprising a plurality of polymerization inhibitor moieties thereon is provided. The method includes conducting a surface treatment to form a plurality of surface functional groups on a surface of the particle; covalently bonding a surface functionalization compound having a first reactive group on one end of the compound and a second reactive group on an opposite end of the compound to the surface of the particle by reacting the first reactive group with one surface functional group of the plurality of surface functional groups; and covalently bonding a reactive polymerization compound having a third reactive group to the surface functionalization compound by reacting the third reactive group and the second reactive group.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

FIG. 1 illustrates an exemplary polymerization inhibitor-functionalized particle, in accordance with embodiments of the present disclosure.

FIG. 2 is a flow diagram illustrating a method for forming polymerization inhibitor-functionalized particles, in accordance with embodiments of the present disclosure.

FIG. 3 illustrates a polymerization inhibitor-functionalized particle at various stages of the method of FIG. 2, in accordance with embodiments of the present disclosure.

FIG. 4 is a flow diagram providing a general overview of a method for fabricating and post-processing an additively manufactured object, in accordance with embodiments of the present disclosure.

FIG. 5 illustrates a representation example of an additive manufacturing device, in accordance with embodiments of the present disclosure.

FIG. 6A shows a representative example of a tooth repositioning appliance, in accordance with embodiments of the present disclosure.

FIG. 6B depicts a tooth repositioning system including a plurality of appliances, in accordance with embodiments of the present disclosure.

FIG. 6C is a flow diagram illustrating a method of orthodontic treatment using a plurality of appliances, in accordance with embodiments of the present disclosure.

FIG. 7 is a flow diagram illustrating a method for designing an orthodontic appliance in accordance with embodiments of the present disclosure.

FIG. 8 is a flow diagram illustrating a method for digitally planning an orthodontic treatment and/or design or fabrication of an appliance, in accordance with embodiments of the present disclosure.

### DETAILED DESCRIPTION

Curable compositions for additive manufacturing are typically composed of polymerizable components (e.g., polymeric precursors including toughness modifiers and reactive diluents) and a photoinitiator. The photoinitiator decomposes under UV radiation, generating radicals that react with the polymeric precursors to form a polymeric material. During an additive manufacturing process, the curable compositions can be prepared and loaded into programmable digitally-controlled light-based curing systems, such as stereolithography (SLA) or digital light processor (DLP)-based additive manufacturing systems (“vat photopolymerization”), where 3D objects (e.g., orthodontic appliances) can be formed in a progressive layer-by-layer, dropwise, or continuous photocuring manner.

Ethylenically unsaturated polymeric precursors, such as acrylates, vinyl ethers, and vinyl esters, employed in curable compositions, are susceptible to undesired premature and spontaneous polymerization when exposed to elevated temperatures and light during various stages of additive manufacturing, as well as during handling, storage, and transport. For instance, the polymerization of these polymeric precursors during transport and storage may lead to an undesired increase in viscosity or gel formation, consequently reducing the processability of the curable compositions.

Moreover, to achieve the desired thermomechanical properties, including elongation, time stress-relaxation, modulus, durability, and toughness, necessary for aligners and other orthodontic appliances to function effectively, high molecular weight prepolymers, such as prepolymers having a number average molecular weight greater than 5,000 Da, are often used. In order to process such resins effectively, hot lithography-based photopolymerization is performed. This process involves pre-heating both the curable compositions and the printing platform to elevated printing temperatures, typically ranging from 60° C. to 120° C. Viscosities of the curable compositions at these temperatures need to be sufficiently low, despite the presence of the high molecular weight prepolymers. However, undesired polymerization at the pre-heating stage may hinder the processability of the curable compositions.

Furthermore, during the printing process used to construct (or print) the 3D objects, the curable composition is deposited one thin layer at a time and cured via exposure to UV light, solidifying it into a solid material matching a programmed computer-assisted design (CAD) file. This process repeats layer by layer until an entire part is built. In the current technology, after a layer is deposited, a leveler removes excess, non-solidified resin material to improve printing accuracy and ensure layer uniformity. Once a single material layer is printed and leveled but before being cured, the leveled material is recirculated for reuse for the printing of another layer. However, repeated use of the curable compositions may render them un-reusable due to undesired polymerization in a few cycles. Since resin materials are expensive, this undesired polymerization during the 3D printing process can increase the overall printing cost.

To prevent the undesired polymerization of resin components, polymerization inhibitors are added to the curable compositions. These inhibitors help prevent premature and spontaneous radical polymerization, thereby substantially prolonging the shelf life of curable compositions, increasing processibility, and reducing manufacturing costs. Typically, the inhibitor concentration in curable compositions is from about 0.1 to 1 wt %. However, since the inhibitor is used to prevent radical polymerization during light an/or thermal exposure by neutralizing free radicals, it effectively halts radical polymerization until it is consumed. Once the inhibitor is consumed, premature polymerization resumes at the same rate as without the inhibitor. Therefore, increasing the amount of inhibitor in the polymerizable resins is desirable to increase the shelf life and the reusability of resins for a longer period without compromising printing efficiency.

Currently, polymerization inhibitors commonly used in curable resin formulations include hydroquinone (HQ), monomethyl ether hydroquinone (MEHQ), and butylated hydroxytoluene (BHT). These inhibitors are classified as non-radical-type polymerization inhibitors and have relatively low polymerization inhibition efficiency. However, highly efficient radical-type polymerization inhibitors such as 2,2,6,6-tetramethyl-1-piperidinyloxy (TEMPO) cannot be used currently due to their toxicity and color. Therefore, it is desirable to incorporate radical-type polymerization inhibitors in curable resin formulations to increase resin shelf life and reusability.

The present disclosure provides solid particle-supported polymerization inhibitors for incorporation into formulations of curable compositions, aimed at inhibiting premature and spontaneous radical polymerization of polymeric precursors during various stages of 3D printing, as well as during handling, storage, and transport. These solid particle-supported polymerization inhibitors are produced through surface functionalization, wherein inhibitor molecules are covalently bonded to the surfaces of the particles. These polymerization inhibitor-functionalized particles can be removed just before the use of the curable compositions, for example, by filtering or centrifuging. Utilizing polymerization inhibitor-functionalized particles thus allows for the reduction of the total inhibitor amount in the final 3D printed objects. Moreover, it enables the utilization of toxic and/or colored inhibitors such as TEMPO without contaminating the 3D printed objects, as these inhibitor-containing particles do not become part of the 3D printed objects. Furthermore, the polymerization inhibitor-functionalized particles can be applied to parts of the 3D printer that are exposed to the curable compositions during the 3D printing process, thereby stabilizing the curable compositions when the 3D printed objects are formed.

### Definitions

All terms, chemical names, expressions, and designations have their usual meanings which are well-known to those skilled in the art. As used herein, the terms “to comprise” and “comprising” are to be understood as non-limiting, i.e., other components than those explicitly named may be included.

Number ranges are to be understood as inclusive, i.e., including the indicated lower and upper limits. Furthermore, the term “about”, as used herein, and unless clearly indicated otherwise, generally refers to and encompasses plus or minus 10% of the indicated numerical value(s). For example, “about 10%” may indicate a range of 9% to 11%, and “about 1” may include the range 0.9-1.1.

As used herein, the term “monomer” refers to a molecule having a reactive functional group capable of undergoing a radical initiated polymerization reaction (e.g., alkenes or functionally substituted alkenes). Such polymerization reaction can be a photo-induced polymerization, e.g., via radical generation. In some embodiments, a monomer component is ethene, chloroethene, fluoroethene, chlorotrifluoroethene, tetrafluoroethene, propene, 2-methylpropene, styrene, propenenitrile, methyl methacrylate, phenyl ethylene, butyl acrylate, 1,6-hexandiol diacrylate, isobornyl methacrylate, homosalic methacrylate, ortho-phenylphenyl methacrylate, etc.

As used herein, the term “polymer” generally refers to a molecule composed of repeating structural units connected by covalent chemical bonds and characterized by a substantial number of repeating units (e.g., equal to or greater than 20 repeating units and often equal to or greater than 100 repeating units and often equal to or greater than 200 repeating units) and a molecular weight greater than or equal to 5,000 Daltons (Da) or 5 kDa, such as greater than or equal to 10 kDa, 15 kDa, 20 kDa, 30 kDa, 40 kDa, 50 kDa, or 100 kDa. Polymers are commonly the polymerization product of one or more monomer precursors. The term polymer includes homopolymers, i.e., polymers consisting essentially of a single repeating monomer species. The term polymer also includes copolymers which are formed when two or more different types (or species) of monomers are linked in the same polymer. Copolymers may comprise two or more different monomer species, and include random, block, alternating, segmented, grafted, tapered and other copolymers. The term “cross-linked polymers” generally refers to polymers having one or multiple links between at least two polymer chains, which can result from multivalent monomers forming cross-linking sites upon polymerization. In various embodiments, a polymer herein is a telechelic polymer capable of undergoing further polymerization reactions, e.g., with other polymerizable components present in a curable composition.

As used herein, the term “oligomer” generally refers to a molecule composed of repeating structural units connected by covalent chemical bonds and characterized by a number of repeating units less than that of a polymer (e.g., equal to or less than 20 or less than 10 repeating units) and a lower molecular weight than polymers, e.g., less than 5,000 Da or less than 2,000 Da, and in various cases from about 0.4 kDa to about 5 kDa. In some cases, oligomers may be the polymerization product of one or more monomer precursors. In various embodiments, an oligomer herein is a telechelic oligomer capable of undergoing further polymerization reactions, e.g., with other polymerizable components present in a curable composition.

As used herein, the terms “telechelic polymer” and “telechelic oligomer” generally refer to a polymer or oligomer the molecules of which are capable of entering, through polymerizable reactive functional groups, into further polymerization.

As used herein, the term “reactive diluent” generally refers to a substance that reduces the viscosity of another substance, such as a monomer or curable. A reactive diluent may become part of another substance, such as a polymer obtained by a polymerization process. In some examples, a reactive diluent is a polymerizable monomer which, when mixed with a curable, reduces the viscosity of the resultant formulation and is incorporated into the polymer that results from polymerization of the formulation.

Oligomer and polymer mixtures can be characterized and differentiated from other mixtures of oligomers and polymers by measurements of molecular weight and molecular weight distributions.

The molecular weight (M) is a number-average molecular weight (Mₙ), which is the average number of repeating units n times the molecular weight or molar mass (Mᵢ) of the repeating unit. The number-average molecular weight (Mₙ) is the arithmetic mean, representing the total weight of the molecules present divided by the total number of molecules.

Photoinitiators described in the present disclosure can include those that can be activated with light and initiate polymerization of the polymerizable components of a resin or formulation. A “photoinitiator”, as used herein, may generally refer to a compound that can produce radical species and/or promote radical reactions upon exposure to radiation (e.g., UV or visible light).

The term “biocompatible,” as used herein, refers to a material that does not elicit an immunological rejection or detrimental effect, referred to herein as an adverse immune response, when it is disposed within an in-vivo biological environment. For example, in embodiments a biological marker indicative of an immune response changes less than 10%, or less than 20%, or less than 25%, or less than 40%, or less than 50% from a baseline value when a human or animal is exposed to or in contact with the biocompatible material. Alternatively, immune response may be determined histologically, wherein localized immune response is assessed by visually assessing markers, including immune cells or markers that are involved in the immune response pathway, in and adjacent to the material. In an aspect, a biocompatible material or device does not observably change immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

“Bioinert” refers to a material that does not elicit an immune response from a human or animal when it is disposed within an in-vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individually or in any combination. Additionally, unless otherwise specified, all isotopic variants of compounds disclosed herein are intended to be encompassed by the disclosure. Specific names of compounds are intended to be exemplary, as it is known that one of ordinary skill in the art can name the same compounds differently.

It is noted that as used herein and in the appended claims, the singular forms “a”, “an”, and “the” include plural reference unless the context clearly dictates otherwise. Thus, for example, reference to “a monomer” includes a plurality of such monomers and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim.

As used herein, the term “group” may refer to a reactive functional group of a chemical compound. Groups of the present compounds refer to an atom or a collection of atoms that are a part of the compound. Groups of the present disclosure may be attached to other atoms of the compound via one or more covalent bonds. Groups may also be characterized with respect to their valence state. The present disclosure includes groups characterized as monovalent, divalent, trivalent, etc. valence states.

As used herein, the term “substituted” refers to a compound (e.g., an alkyl chain) wherein a hydrogen is replaced by another reactive functional group or atom, as described herein.

As used herein, a broken line in a chemical structure can be used to indicate a bond to the rest of the molecule. For example, [symbol] in

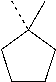

is used to designate the 1-position as the point of attachment of 1-methylcyclopentate to the rest of the molecule. Alternatively,

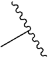

in, e.g.,

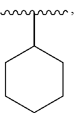 [SMILES: *C1CCCCC1]

can be used to indicate that the given moiety, the cyclohexyl moiety in this example, is attached to a molecule via the bond that is “capped” with the wavy line.

“Aliphatic” or “aliphatic group” as used herein means a straight-chain or branched C₁-C₃₀ hydrocarbon chain that is completely saturated or that contains one or more units of unsaturation, or a monocyclic C₃-C₂₀ hydrocarbon or bicyclic C₈-C₂₀ hydrocarbon that is completely saturated or that contains one or more units of unsaturation, but which is not aromatic (also referred to herein as “cycloalkyl”), that has a single point of attachment to the rest of the molecule where in any individual ring in said bicyclic ring system has 3-7 members. For example, suitable aliphatic groups include, but are not limited to, linear, branched or cyclic alkyl, alkenyl, alkynyl groups and hybrids thereof such as (cycloalkyl)alkyl, (cycloalkenyl)alkyl or (cycloalkyl)alkenyl.

Alkyl groups include straight-chain, branched and cyclic alkyl groups, unless otherwise defined for a compound or genus of compounds. Alkyl groups include those having from 1 to 30 carbon atoms, unless otherwise defined. Thus, alkyl groups can include small alkyl groups having 1 to 3 carbon atoms, medium length alkyl groups having from 4-10 carbon atoms, as well as long alkyl groups having more than 10 carbon atoms, particularly those having 10-30 carbon atoms. The term cycloalkyl specifically refers to an alkyl group having a ring structure such as a ring structure comprising 3-30 carbon atoms, optionally 3-20 carbon atoms and optionally 3-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkyl groups can also carry alkyl groups. Cycloalkyl groups can include bicyclic and tricyclic alkyl groups. Alkyl groups are optionally substituted, as described herein. Substituted alkyl groups can include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Unless otherwise defined herein, substituted alkyl groups include fully halogenated or semihalogenated alkyl groups, such as alkyl groups having one or more hydrogens replaced with one or more fluorine atoms, chlorine atoms, bromine atoms and/or iodine atoms. Thus, substituted alkyl groups can include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alkyl portion of the groups is substituted as provided herein in connection with the description of alkyl groups. As used herein MeO— refers to CH₃O—. Moreover, a thioalkoxy group, as used herein is an alkyl group that has been modified by linkage to a sulfur atom (instead of an oxygen) and can be represented by the formula R—S.

Alkenyl groups include straight-chain, branched and cyclic alkenyl groups. Alkenyl groups include those having 1, 2 or more double bonds and those in which two or more of the double bonds are conjugated double bonds. Unless otherwise defined herein, alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkenyl groups can also carry alkyl groups. Cycloalkenyl groups can include bicyclic and tricyclic alkenyl groups. Alkenyl groups are optionally substituted. Unless otherwise defined herein, substituted alkenyl groups include among others those that are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups can include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms.

Aryl groups include groups having one or more 5-, 6-, 7- or 8-membered aromatic rings, including heterocyclic aromatic rings. The term heteroaryl specifically refers to aryl groups having at least one 5-, 6-, 7- or 8-member heterocyclic aromatic ring. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein provided in a covalently bonded configuration in the compounds of the disclosure at any suitable point of attachment. In some embodiments, aryl groups contain between 5 and 30 carbon atoms. In some embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

Arylalkyl groups are alkyl groups substituted with one or more aryl groups wherein the alkyl groups optionally carry additional substituents and the aryl groups are optionally substituted. Specific arylalkyl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms.

As used herein, the terms “alkylene” and “alkylene group” are used synonymously and refer to a divalent group “—CH₂—” derived from an alkyl group as defined herein. The disclosure includes compounds having one or more alkylene groups. Alkylene groups in some compounds function as attaching and/or spacer groups. Compounds of the disclosure may have substituted and/or unsubstituted C₁-C₂₀ alkylene, C₁-C₁₀ alkylene and C₁-C₆ alkylene groups.

As used herein, the terms “cycloalkylene” and “cycloalkylene group” are used synonymously and refer to a divalent group derived from a cycloalkyl group as defined herein. The disclosure includes compounds having one or more cycloalkylene groups. Cycloalkyl groups in some compounds function as attaching and/or spacer groups. Compounds of the disclosure may have substituted and/or unsubstituted C₃-C₂₀ cycloalkylene, C₃-C₁₀ cycloalkylene and C₃-C₅ cycloalkylene groups.

As used herein, the terms “arylene” and “arylene group” are used synonymously and refer to a divalent group derived from an aryl group as defined herein. The disclosure includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as attaching and/or spacer groups. Arylene groups in some compounds function as chromophore, fluorophore, aromatic antenna, dye and/or imaging groups. Compounds of the disclosure include substituted and/or unsubstituted C₃-C₃₀ arylene, C₃-C₂₀ arylene, C₃-C₁₀ arylene and C₁-C₅ arylene groups.

As used herein, the terms “heteroarylene” and “heteroarylene group” are used synonymously and refer to a divalent group derived from a heteroaryl group as defined herein. The disclosure includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as attaching and/or spacer groups. Heteroarylene groups in some compounds function as chromophore, aromatic antenna, fluorophore, dye and/or imaging groups. Compounds of the disclosure include substituted and/or unsubstituted C₃-C₃₀ heteroarylene, C₃-C₂₀ heteroarylene, C₁-C₁₀ heteroarylene and C₃-C₅ heteroarylene groups.

As used herein, the terms “alkenylene” and “alkenylene group” are used synonymously and refer to a divalent group derived from an alkenyl group as defined herein. The invention includes compounds having one or more alkenylene groups. Alkenylene groups in some compounds function as attaching and/or spacer groups. Compounds of the disclosure include substituted and/or unsubstituted C₂-C₂₀ alkenylene, C₂-C₁₀ alkenylene and C₂-C₅ alkenylene groups.

As used herein, the terms “cycloalkenylene” and “cycloalkenylene group” are used synonymously and refer to a divalent group derived from a cycloalkenyl group as defined herein. The disclosure includes compounds having one or more cycloalkenylene groups. Cycloalkenylene groups in some compounds function as attaching and/or spacer groups. Compounds of the disclosure include substituted and/or unsubstituted C₃-C₂₀ cycloalkenylene, C₃-C₁₀ cycloalkenylene and C₃-C₅ cycloalkenylene groups.

As used herein, the terms “alkynylene” and “alkynylene group” are used synonymously and refer to a divalent group derived from an alkynyl group as defined herein. The disclosure includes compounds having one or more alkynylene groups. Alkynylene groups in some compounds function as attaching and/or spacer groups. Compounds of the disclosure include substituted and/or unsubstituted C₂-C₂₀ alkynylene, C₂-C₁₀ alkynylene and C₂-C₅ alkynylene groups.

As used herein, the terms “halo” and “halogen” can be used interchangeably and refer to a halogen group such as a fluoro (—F), chloro (—Cl), bromo (—Br) or iodo (—I).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and reactive functional groups, for example, provided as substituents.

The term “carbocyclic” refers to ring structures containing only carbon atoms in the ring. Carbon atoms of carbocyclic rings can be bonded to a wide range of other atoms and reactive functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy)ₙ-alkoxy wherein n is an integer from 1 to 10, e.g., 1 to 4, and in some embodiments 1 to 3.

The term “heteroalkyl”, as used herein, generally refers to an alkyl, alkenyl or alkynyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, or from 1 to 12 non-hydrogen atoms, or from 1 to 6 non-hydrogen atoms, or from 1 to 4 non-hydrogen atoms. Heteroalkyl groups may be straight or branched, and saturated or unsaturated. Unsaturated heteroalkyl groups have one or more double bonds and/or one or more triple bonds. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

The term “carbonyl”, as used herein, for example in the context of C₁₋₆ carbonyl substituents, generally refers to a carbon chain of given length (e.g., C₁₋₆), wherein each of the carbon atom of a given carbon chain can form the carbonyl bond, as long as it chemically feasible in terms of the valence state of that carbon atom. Thus, in some instance, the “C₁₋₆ carbonyl” substituent refers to a carbon chain of between 1 and 6 carbon atoms, and either the terminal carbon contains the carbonyl functionality, or an inner carbon contains the carbonyl functionality, in which case the substituent could be described as a ketone. The term “carboxy”, as used herein, for example in the context of C₁₋₆ carboxyl substituents, generally refers to a carbon chain of given length (e.g., C₁₋₆), wherein a terminal carbon contains the carboxy functionality, unless otherwise defined herein.

The term “carboxylic acid” as used herein refers to —C(O)OH.

The term “thiocyanate” as used herein refers to —S—C≡N group.

As to any of the groups described herein that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

Unless otherwise defined herein, optional substituents for any alkyl, alkenyl and aryl group include substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen or an alkyl group or an aryl group and more specifically where R is a methyl, ethyl, propyl, butyl, or phenyl group all of which groups are optionally substituted;
—COR, where R is a hydrogen or an alkyl group or an aryl group and more specifically where R is a methyl, ethyl, propyl, butyl, or phenyl group all of which groups are optionally substituted;
—CON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂, where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR, where R is an alkyl group or an aryl group and more specifically where R is a methyl, ethyl, propyl, butyl, or phenyl group, all of which are optionally substituted;
—OCOOR, where R is an alkyl group or an aryl group;
—SO₂N(R)₂, where each R, independently of each other R, is a hydrogen, or an alkyl group, or an aryl group all of which are optionally substituted and wherein R and R can form a ring that can contain one or more double bonds and can contain one or more additional carbon atoms; and
—OR, where R is H, an alkyl group, an aryl group, or an acyl group all of which are optionally substituted. In a particular example R can be an acyl yielding —OCOR″, wherein R″ is a hydrogen or an alkyl group or an aryl group and more specifically where R″ is methyl, ethyl, propyl, butyl, or phenyl groups all of which groups are optionally substituted

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, as further described herein, the compounds of this disclosure can include all stereochemical isomers (and racemic mixtures) arising from the substitution of these compounds.

### Polymerization Inhibitor-Functionalized Particles

One aspect of the present disclosure provides a surface functionalized particle comprising a plurality of polymerization inhibitor moieties covalently bonded to the surface of the particle.

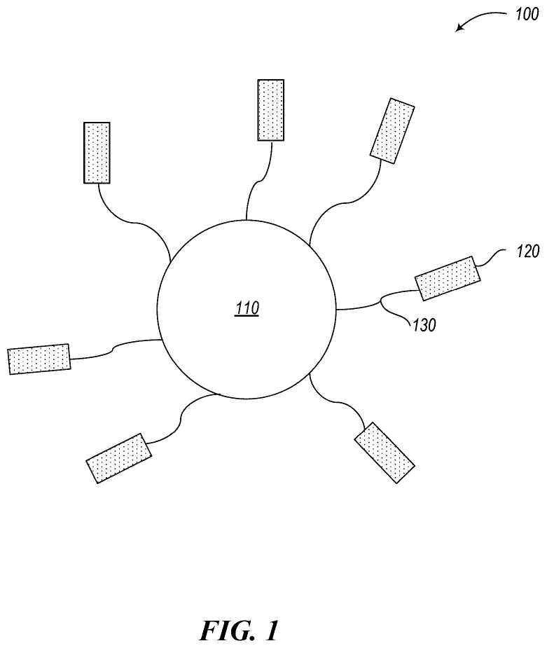

FIG. 1 illustrates an exemplary surface functionalized particle 100, in accordance with some embodiments of the present disclosure. The surface functionalized particle 100 includes a particle 110 and a plurality of polymerization inhibitor moieties 120 each covalently bonded to a surface of the particle 110 via a linker 130.

In some embodiments, the particle 110 may include an inorganic material such as silicon dioxide (silica), aluminum oxide (alumina), titanium dioxide, zinc oxide, zirconium dioxide, cerium dioxide, manganese dioxide, iron oxide, calcium oxide, glass, or quartz. In some embodiments, the particle 110 may include an organic polymer such as polyamide, polystyrene (PS), polybutadiene, polyethylene, polypropylene, polyvinyl alcohol, polyvinyl ether, polyvinyl ester, polyvinyl halides such as poly(vinyl chloride), polyvinylpyrrolidone, polysiloxane, poly(vinyl acetate), or a copolymer thereof. In some embodiments, the particle 110 may include a copolymer having pendant reactive groups attached to the polymer backbone. In some embodiments, the particle 110 includes poly(meth)acrylate acid-co-polystyrene or poly(meth)acrylate-co-poly(hydroxy styrene). In some embodiments, the polymer can be a naturally occurring material, such as chitosan and cellulose. In some more specific embodiments, the particle 110 is made of silica or polystyrene. In some embodiments, the particle 110 is an inorganic-organic hybrid particle. In some embodiments, the hybrid particle is composed of an inorganic core and a polymer shell. In some embodiments, the hybrid particle is composed of a polymer core and an inorganic shell. The inorganic materials and organic polymer materials suitable for making hybrid particles are described above. In some embodiments, the particle includes a polystyrene core and a silica shell.

The particle 110 may be any shape, such as rod-like, plate-like, ellipsoidal, cubic, or spherical shape. The form of the particle 110 is not limited in any manner. In various embodiments, the particle 110 can be in the form of, for example, tubes, fibers, shafts, pillars, wires, rods, needles, and whiskers.

The particle 110 may have an average size in the range from about 1 micron (μm) to about 3000 μm. In some embodiments, the particle 110 may have an average size from about 1 μm to about 10 μm, from about 10 μm to about 50 μm, from about 50 μm to about 100 μm, from about 100 m to about 200 μm, from about 200 μm to about 500 μm, from about 500 μm to about 1000 μm, from about 1000 μm to about 2000 μm, or from about 2000 μm to about 3000 am. In some embodiments, the particle 110 may have an average size from about 10 μm to about 2000 μm, from about 100 μm to about 2000 μm, from about 200 μm to about 2000 μm, from about 500 μm to about 2000 μm, or from about 1000 μm to about 2000 μm. In some embodiments, the particles 110 are nanoparticles having an average size in the range from about 50 nm to about 1 μm, for example, about 100 nm, 200 nm, 300 nm, 400 nm, 500 nm, 600 nm, 700 nm, 800 nm, or 900 nm.

The polymerization inhibitor moiety 120 is adapted to inhibit the formation of the polymeric material from at least a portion of the polymeric precursors in curable compositions due to the premature and spontaneous radical polymerization of these polymeric precursors. In some embodiments, the polymerization inhibitor moiety 120 is derived from a radical polymerization inhibitor. In some embodiments, the polymerization inhibitor moiety 120 is derived from a non-radical polymerization inhibitor. In some embodiments, the polymerization inhibitor comprises phenothiazine, butylated hydroxytoluene (BHT), 4-methoxyphenol (MEHQ), 2,2,6,6-tetramethylpiperidinyloxy (TEMPO), Irganox 565 (2,6-di-tert-butyl-4-(4,6-bis(octylthio)-1,3,5-triazin-2-ylamino)phenol), Irganox 1010 (pentaerythritol tetrakis(3-(3,5-di-tert-butyl-4-hydroxyphenyl)propionate), Irganox MD 1024 (2′,3-bis((3-(3,5-di-tert-butyl-4-hydroxyphenyl)propionyl))propionohydrazide), Irganox 1035 (thiodiethylene bis(3-(3,5-di-tert-butyl-4-hydroxy-phenyl)propionate)), Irganox 1726 (2,4-bis(dodecylthiomethyl)-6-methylphenol), Irgafos 168 (tris(2,4-di-tert-butylphenyl)phosphite), Irgafos 126 (bis(2,4-di-tert-butylphenol)pentaerythritol diphosphate), Revonox 420V (bis(alkyl hydrogenated palm-oil) hydroxy amines), Revonox 501 (multi-functional benzofuranone-based antioxidant), Revonox 608 (bis (2,4-dicumylphenyl) pentaerythritol diphosphate), vitamin E (α-tocopherol), 3-methyl-2-nitrobenzyl alcohol, 2-nitrobenzyl alcohol, or combinations thereof. In some embodiments, the polymerization inhibitor is a natural antioxidant such as BHT, vitamin E, vitamin C (L-ascorbic Acid), quercetin (2-(3,4-dihydroxyphenyl)-3,5,7-trihydroxy-4H-1-benzopyran-4-one), (−)-epigallocatechin gallate ((−)-cis-2-(3,4,5-trihydroxyphenyl)-3,4-dihydro-1(2H)-benzopyran-3,5,7-triol 3-gallate), ellagic Acid (4,4′,5,5′,6,6′-Hexahydroxydiphenic acid 2,6,2′,6′-dilactone), lycopene (ψ,ψ-carotene, 2,6,10,14,19,23,27,31-octamethyl-dotriaconta-2,6,8,10,12,14,16,18,20,22,24,26,30-tridecaene), myricetin (3,3′,4′,5,5′,7-hexahydroxyflavone), (±)-α-lipoic acid ((±)-1,2-dithiolane-3-pentanoic acid), β-carotene, coenzyme Q10 (ubiquinone-10), (+)-catechin hydrate ((+)-cyanidol-3, (2R,3S)-2-(3,4-dihydroxyphenyl)-3,4-dihydro-1(2H)-benzopyran-3,5,7-triol), or 1,1-diphenylethylene.

The linker 130 covalently bonds the polymerization inhibitor moiety 120 to the surface of the particle 110. In some embodiments, the linker 130 is an alkylene or heteroalkylene linker. In some embodiments, the linker 130 comprises one or more of O, N, S, or Si atoms. In some embodiments, the linker 130 has one of the following structures:

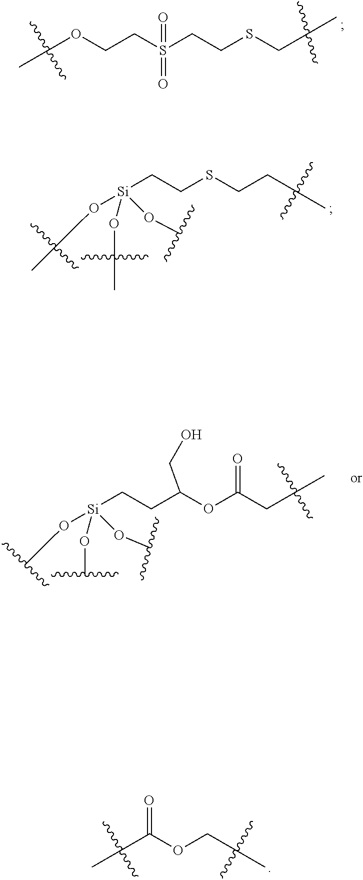 [SMILES: *CSCCS(=O)(=O)CCO* ; *CCSCC[Si](O*)(O*)O* ; *CC(=O)OC(CO)CC[Si](O*)(O*)O* ; *COC(*)=O]

The surface functionalized particle 100 in accordance with the present disclosure may be made by covalently binding the polymerization inhibitor moiety 120 to the exterior surface of the particle 110. Covalent bonding of a polymerization inhibitor moiety 120 to a particle 110 may be via a variety of linkages, such as via an amide, ether, ester, carbonate, thiol, urea, or urethane linkage.

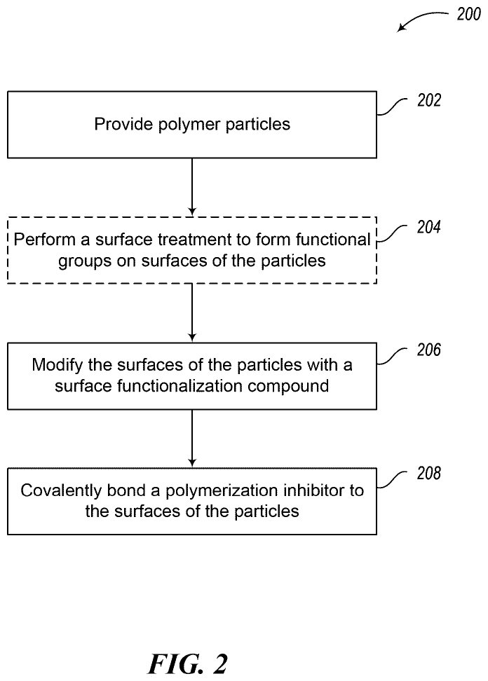

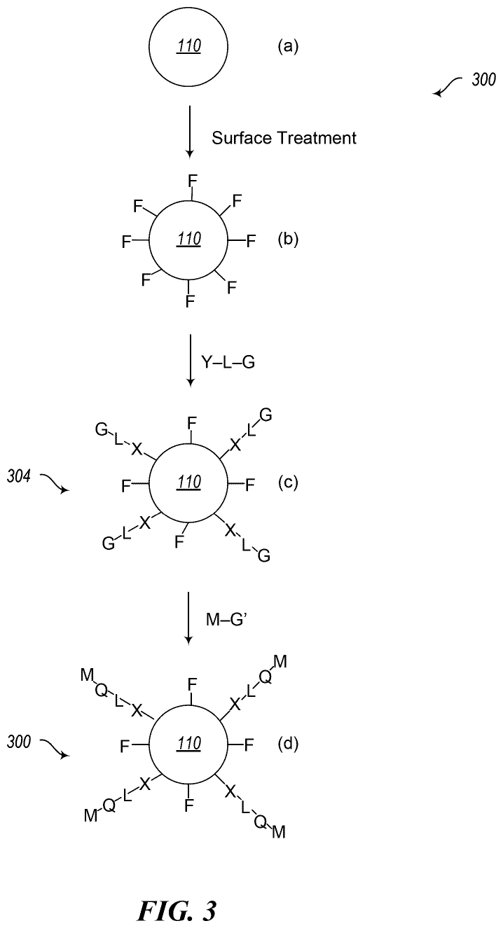

In another aspect of the present disclosure, provided is a method for preparing surface functionalized particles 100 comprising particles 110 and a plurality of polymerization inhibitor moieties 120 covalently bonded to the surfaces of the particles 110. FIG. 2 is a flow diagram illustrating a method 200 for forming surface functionalized particles 100, in accordance with some embodiments of the present disclosure. FIG. 3 illustrates a surface functionalized particle 300 at various stages of the method 200.

At operation 202 of the method 200, particles 110 are provided. An example of such particles is shown in (a) of FIG. 3. The particles 110 can be any inorganic particles or organic particles described above. In some embodiments, the particles 110 are silica particles or polystyrene particles that are commercially available. In some embodiments, the particles 110 comprise a copolymer having pendant reactive groups. The copolymer may be, for example, a diblock copolymer formed by polymerization of a (meth)acrylate-based monomer and a styrene-based monomer. The pendant reactive group can be any group having a complementary reactivity to the reactive group in the polymerization inhibitor for covalently bonding the polymerization inhibitor to the surface of the particles 110. In some embodiments, the pendant reactive groups may include carboxyl or hydroxyl groups.

In some embodiments, the particles 110 include a copolymer having the following structure (I):

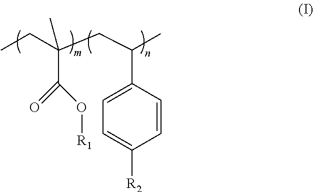

wherein:
   R₁ is, at each occurrence, independently, H, alkyl, cycloalkyl, aryl or heteroaryl;
   R₂ is, at each occurrence, independently, H, OH, alkyl or alkoxy; and
   m and n are each an integer of one or greater,
   provided that the copolymer contains at least one carboxyl or hydroxyl group.

In structure (I), m and n are selected such that the number average molecular weight of the copolymer is at least about 0.5 kDa, at least about 1 kDa, at least about 2 kDa, at least about 5 kDa, at least about 8 kDa, at least about 9 kDa, at least about 10 kDa, at least about 12 kDa, at least about 15 kDa, at least about 20 kDa, at least about 25 kDa, at least about 30 kDa, at least about 40 kDa, at least about 50 kDa, at least about 60 kDa, at least about 70 kDa, at least about 80 kDa, at least about 90 kDa, at least about 100 kDa, or at least about 200 kDa.

In some embodiments, m is from 1 to 1,000.

In some embodiments, n is from 1 to 1,000.

In some embodiments, the copolymer of structure (I) has the following structure:

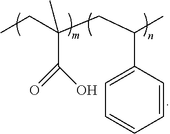

At operation 204 of the method 200, the surfaces of particles 110 may undergo a surface treatment to form surface functional groups (F) thereon, so that the subsequent surface modification can be effected. An example of such particles bearing the surface functional groups (F) is shown in (b) of FIG. 3. In some embodiments, the surface functional groups (F) include hydroxyl (—OH) groups, carboxyl (—C(═O)OH groups, carbonyl (—C═O) groups, thiol (—SH) groups, amino (—NH₂) groups, or combinations thereof.

In some embodiments, the surface treatment of particles 110 may involve a wet surface treatment method, wherein the particles 110 are immersed in a solution. In some embodiments, the solution includes a piranha solution, which contains a mixture of H₂SO₄ and H₂O₂, a sulfuric acid (H2_{S}O₄) solution, a hydrochloric acid (HCl) solution, or an alkali metal hydroxide solution. In other embodiments, the surface treatment of particles 110 may be conducted using a dry surface treatment method, such as oxygen plasma treatment or UV ozone treatment. In some embodiments, the particles 110 are dispersed in a piranha solution to form hydroxyl groups on the surfaces of the particles 110. The piranha solution can have any ratio of H₂SO₄ and H₂O₂. In some embodiments, the piranha solution is prepared by mixing, for example, a concentrated H₂SO₄ and 30% H₂O₂ at a ratio of 3:1.

In some embodiments, after the surface treatment, one or more post-treatment processes may be performed. In some embodiments, the post-treatment includes annealing, such as furnace annealing, rapid thermal annealing, laser annealing, UV annealing, electron beam annealing, or combinations thereof.

Operation 204 is optional and may be omitted in some embodiments. For example, in instances where the particles 110 are silica particles containing silanol groups on the surfaces, no surface treatment is needed, and operation 204 is omitted.

At operation 206 of the method 200, the surfaces of particles 110 may be modified by a surface functionalization compound to form surface modified particles 304. An example of such surface modified particles 304 is shown in (c) of FIG. 3.

The surface functionalization compound can be any compound that contains a first reactive group at one end capable of reacting with the surface functional group F on the surfaces of the particles 110, and a second reactive group G at an opposite end capable of reacting with a reactive group G′ in a reactive polymerization inhibitor M-G′.

In some embodiments, the surface functionalization compound has the following structure (II):

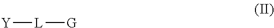

wherein:
L is an alkylene or heteroalkylene linker;
Y is a first reactive group; and
G is a second reactive group.

In some embodiments, L is an alkylene linker. In some embodiments, L is C₁-C₁₅ alkylene.

In some embodiments, L is a heteroalkylene linker. In some embodiments, L is C₁-C₁₈ alkylene oxide. In some embodiments, L is polyethylene glycol.

The first reactive group Y is capable of forming a covalent bond with a complementary surface functional group of particles 110. In some embodiments, Y is a silanol, hydroxyl, carboxylate, or amino group.

The second reactive group G is capable of forming a covalent bond with a complementary reactive group coupled to the polymerization inhibitor. In some embodiments, G is a moiety comprising aldehyde, alkene, alkyne, azide, amino, N.N′-carbonyl diimidazole, carboxylate, epoxy, hydrazide, hydroxyl, iminodiacetic acid, iodoacetyl, N-hydroxysuccinimide (NHS), pentadiene, silanol, thiol, tosyl, vinylsulfone, or combinations thereof.

In some embodiments, G is alkene, amino, carboxylate, epoxy, hydroxyl, or thiol.

In some embodiments, the surface functionalization compound is an amino silane represented by amino-(alkyl)ₚ-silane, wherein the alkyl group is C₁-C₁₅ alkylene. Examples of amino silanes include, but are not limited to, methoxysilanes, ethoxysilanes, and chlorosilanes. Examples of methoxysilanes include, but are not limited to, 2-aminoethyl-3-aminopropyl trimethoxysilane (AEAPTS), aminopropyltrimethoxysilane and aminophenyltrimethoxysilane. Examples of ethoxysilanes include, but are not limited to, aminoundecyltriethoxysilane, aminopropylmethyldiethoxysilane, and aminobutyltriethoxysilane. In some embodiments, the amino silane is AEAPTS.

In some embodiments, the surface functionalization compound is an epoxy silane represented by epoxy-(alkyl)ₚ-silane, wherein the alkyl group is C₁-C₁₅ alkylene. In some embodiments, the epoxy silane is epoxy propyltrimethoxysilane.

In some embodiments, the surface functionalization compound is a thiol silane represented by thiol-(alkyl)ₚ-silane, wherein the alkyl group is C₁-C₁₅ alkylene. In some embodiments, the thiol silane is thiolethyltrimethoxysilane.

Operation 206 is optional and can be omitted in some embodiments. In instances where operation 206 is omitted, the reactive polymerization inhibitor M-G′ directly reacts with the surface functional group (F) on the particle surface.

At operation 208 of the method 200, the surface modified particles 304 are reacted with a reactive polymerization inhibitor M-G′ to yield the surface functionalized particles 300 comprising polymerization inhibitor moieties M thereon. An example of such surface functionalized particles 300 is shown in (d) of FIG. 3.

The reactive polymerization inhibitor M-G′ contains a reactive group having a complementary reactivity to the second reactive group G in the surface functionalization compound.

In some embodiments, the reactive polymerization inhibitor has the following structure (III):

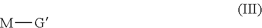

wherein:
M is a moiety comprising a polymerization inhibitor; and
G′ is a reactive group.

In some embodiments, M has one of the following structures:

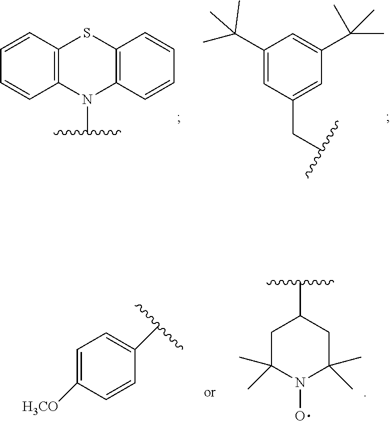

G′ is a reactive group that is capable of forming a covalent bond with the surface modified particle 304. In some embodiments, G′ is a moiety comprising aldehyde, alkene, alkyne, azide, amino, N.N′-carbonyl diimidazole, carboxylate, epoxy, hydrazide, hydroxyl, iminodiacetic acid, iodoacetyl, N-hydroxysuccinimide (NHS), pentadiene, silanol, thiol, tosyl, vinylsulfone, or combinations thereof.

In some embodiments, G′ is alkene, amino, carboxylate, hydroxyl, or thiol.

In some embodiments, M-G′ has one of the following structures:

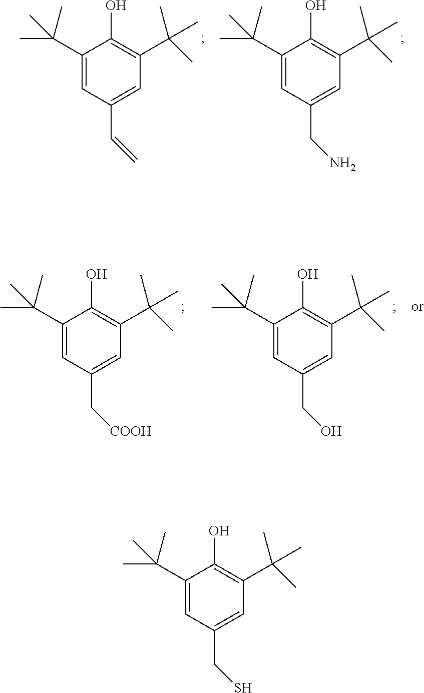

In some embodiments, M-G′ has one of the following structures:

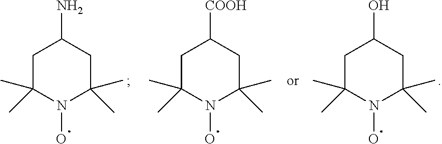

### Curable Compositions

In some embodiments, the present disclosure provides stable curable compositions comprising a plurality of polymerizable components and a plurality of polymerization inhibitor-functionalized particles. The polymerization inhibitor-functionalized particles improve processing, storage, and transport stability of the curable compositions by inhibiting premature and spontaneous radical polymerization of the resin components, thereby minimizing drafts of resin viscosity and reducing gel time. In some embodiments, the curable composition herein is a photopolymerizable composition, a thermo-polymerizable composition, or a combination thereof. In some embodiments, a curable composition includes polymerization inhibitor-functionalized particles, one or more species of telechelic compounds (e.g., toughness modifiers and glass transition temperature modifiers), and one or more species of polymerizable monomers (e.g., reactive diluents). The curable compositions provided herein can comprise a greater amount of polymerization inhibitor-functionalized particles to ensure inhibition of premature and spontaneous radical polymerization of the polymerizable components of the curable compositions compared to conventional resin compositions using non-particle-supported polymerization inhibitors. As a result, the storage shelf life of the curable compositions can be improved, and the shipping and warehouse storage costs can be reduced. Utilizing polymerization inhibitor-functionalized particles also helps to improve processability and reusability of the curable compositions during the 3D printing process. As a result, the manufacturing costs can also be reduced.

### 1) Polymerization Inhibitor-Functionalized Particles

A curable composition of the present disclosure can comprise a plurality of polymerization inhibitor-functionalized particles discussed herein. In some embodiments, the curable composition may comprise 1 to 10%, based on the total weight of the composition, of the polymerization inhibitor.

### 2) Reactive Diluents

A curable composition of the present disclosure can comprise one or more species of polymerizable monomers. Such polymerizable monomers can be used as reactive diluents to reduce the viscosity of the curable composition. A reactive diluent can reduce the viscosity of the curable composition by at least about 5% compared to a resin composition that does not comprise the reactive diluent. In some instances, a reactive diluent can reduce the viscosity of a curable composition by at least about 5%, 10%, 20%, 30%, 40%, or 50%.

In various embodiments, a reactive diluent can comprise an acrylate or methacrylate moiety for incorporation into an oligomeric or polymeric backbone, coupled to a linear or cyclic (e.g., mono-, bi-, or tri-cyclic) side-chain moiety. Generally, any aliphatic, cycloaliphatic, or aromatic molecule with a mono-functional polymerizable reactive functional group can be used (also includes liquid crystalline monomers). In some embodiments, the polymerizable reactive functional group is an acrylate or methacrylate group. Specific reactive diluents suitable for use in the subject compositions include, but are not limited to, 3,3,5-trimethylcyclohexyl 2-(methacryloxy)benzoate (HSMA), benzyl salicylate methacrylate (BSMA), bisphenol A-glycidyl methacrylate (BisGMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA), the corresponding acrylates, and combinations thereof. The polymerization inhibitor-functionalized particles help to prevent undesired oxidation of the reactive diluent.

In some embodiments, the reactive diluent of the present disclosure can have a low vapor pressure at an elevated temperature and a high boiling point. Such low vapor pressure can be particularly advantageous for use of such monomer in polymerizable (e.g., photopolymerizable) resin compositions and additive manufacturing, where elevated temperatures (e.g., 60° C., 80° C., 90° C., or higher) may be used. In various instances, the reactive diluent can have a vapor pressure of at most about 12 Pa at 60° C. In various instances, the reactive diluent can have a vapor pressure of at most about 2 Pa to 10 Pa at 60° C. In various instances, the reactive diluent can have a vapor pressure of at most about 2 Pa to 5 Pa at 60° C. Thus, in some embodiments, the reactive diluent of the present disclosure can have a low mass loss at an elevated temperature. As used herein, a mass loss of a compound at a certain temperature (e.g., 90° C.) for a certain time period (e.g., 2 hours) can be used as a measure for volatility of such compounds. Herein, “substantially no volatility” can refer to a mass loss less than 1 wt % at the respective temperature, e.g., at 90° C. for 2 hours. In various instances, the reactive diluent of the present disclosure can have a mass loss of less than 1 wt % at the temperature of 90° C. after heating at that temperature for 2 hours. In some embodiments, the reactive diluent can have a mass loss of less than about 0.5% after heating at 90° C. for 2 h. In some embodiments, the reactive diluent can have a mass loss of about 0.1% to about 0.45% after heating at 90° C. for 2 h. In some embodiments, the reactive diluent can have a mass loss of about 0.05% to about 0.25% after heating at 90° C. for 2 h.

In some embodiments, the reactive diluent of the present disclosure can have a molecular weight of at least about 150 Da, 200 Da, 250 Da, 300 Da, 350 Da, 400 Da, or at least about 450 Da. In some instances, the reactive diluent has a molecular weight of less than about 750 Da.

In some embodiments, the reactive diluent of the present disclosure can have a melting point of at least about 20° C., 30° C., 40° C., 50° C., or higher. The melting point of the reactive diluent is lower than the processing temperatures employed in current high temperature lithography-based photopolymerization processes, which are typically in the range of 50 to 120° C., such as 90 to 120° C. Therefore, the reactive diluents can have a melting point less than 120° C., less than 90° C., less than 70° C., or even less than 50° C. or less than 30° C., which provides for low viscosities of the melts and, consequently, for more pronounced viscosity-lowering effects when they are used as reactive diluents for resin compositions to be cured by means of high temperature lithography-based polymerization. In some cases, they are liquid at room temperature, which, in addition to the above advantages, facilitates their handling.

In some embodiments, the curable composition comprises 1 to 75 wt %, 1 to 70 wt %, 1 to 60 wt %, 1 to 50 wt %, 1 to 40 wt %, 1 to 30 wt %, 1 to 25 wt %, 1 to 20 wt %, 10 to 70 wt %, 10 to 70 wt %, 10 to 60 wt %, 10 to 50 wt %, 10 to 40 wt %, 10 to 30 wt %, 10 to 25 wt %, 20 to 70 wt %, 20 to 60 wt %, 20 to 50 wt %, 20 to 40 wt %, 20 to 35 wt %, or 20 to 30 wt %, based on the total weight of the composition, of the reactive diluent. In certain embodiments, the curable composition may comprise 5 to 50 wt % or 20 to 50 wt %, based on the total weight of the composition, of the reactive diluent. In certain embodiments, the curable composition may comprise 20 to 50 wt %, based on the total weight of the composition, of the reactive diluent.

### 3) Toughness Modifiers

A curable composition can comprise one or more species of telechelic compounds. Such telechelic compound can be a telechelic oligomer or a telechelic polymer. In some embodiments, the telechelic compound comprises an oligomeric or polymeric chain of interconnected monomeric units having at least one terminal reactive functional group coupled at each end. In some embodiments, the linear oligomeric or polymeric chain is selected from (poly)carbonate-(poly)urethane, (poly)ester-(poly)urethane, (poly)ether-(poly)urethane, (poly)thioether-(poly)urethane, hydrogenated (poly)butadiene, (poly)ether, (poly)ester or (poly)urethane, and the terminal reactive functional group is selected from an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide, and a styrenyl. The polymerization inhibitor-functionalized particles help to prevent undesired polymerization of the toughness modifier.

In some embodiments, the first terminal end, the second terminal end, or both, comprises a reactive functional group having one of the following structures:

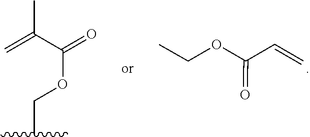

In some embodiments, the first terminal end, the second terminal end, or both, has a reactive functional group having the following structure:

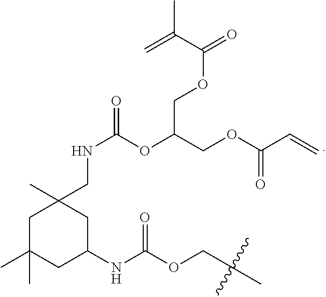 [SMILES: *COC(=O)NC1CC(C)(C)CC(C)(CNC(=O)OC(COC(=O)C=C)COC(=O)C(=C)C)C1]

In some embodiments, the telechelic compound has the following structure:

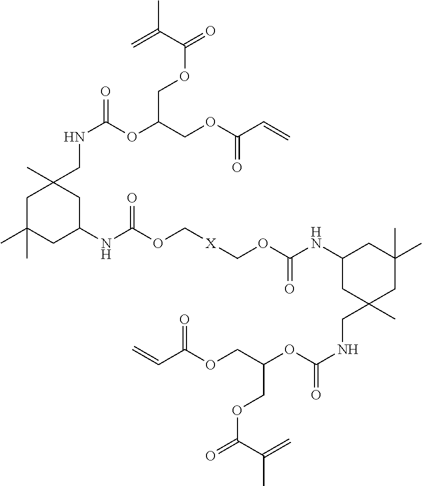

wherein X is an oligomeric or polymeric chain of (poly)carbonate-(poly)urethane, (poly)ester-(poly)urethane, (poly)ether-(poly)urethane, (poly)thioether-(poly)urethane, hydrogenated (poly)butadiene, (poly)ether, (poly)ester or (poly)urethane.

In some embodiments, the telechelic compound is a telechelic polymer having a number average molecular weight greater than 5 kDa. Such telechelic polymer can be used as a toughness modifier for a polymeric material to be generated using a curable composition herein. The toughness modifier provides for high elongation at break and toughness via strengthening effects.

The toughness modifier of the subject compositions may have a low glass transition temperature (T_{g}), such as a T_{g} less than 0° C., which can add to tough behavior if used above its glass transition temperature. In some examples, the T_{g} of the toughness modifier may be less than 25° C., such as less than 15° C., less than 10° C., less than 5° C., less than 0° C., less than −5° C., or less than −10° C. The T_{g} of a polymer or composition described herein may be assessed using dynamic mechanical analysis (DMA) and is provided herein as the tan δ peak.

The toughness modifier can have a number average molecular weight greater than 5 kDa, 6 kDa, 7 kDa, 8 kDa, 9 kDa, 10 kDa, 11 kDa, 12 kDa, 13 kDa, 14 kDa, 15 kDa, 16 kDa, 17 kDa, 18 kDa, 19 kDa, 20 kDa, 21 kDa, 22 kDa, 23 kDa, 24 kDa, or greater than 25 kDa. In some embodiments, the toughness modifier has a number average molecular weight ranging from 7-15 kDa. In certain embodiments, the toughness modifier has a number average molecular weight ranging from 8-10 kDa, 8-15 kDa, 9-10 kDa, 9-15 kDa, 10-20 kDa, 11-15 kDa, 12-15 kDa, 15-20 kDa, 13-15 kDa, or 17-20 kDa.

The curable composition can comprise 1 to 75 wt %, 1 to 70 wt %, 1 to 60 wt %, 1 to 50 wt %, 1 to 40 wt %, 1 to 30 wt %, 1 to 25 wt %, 10 to 75 wt %, 10 to 70 wt %, 10 to 60 wt %, 10 to 50 wt %, 10 to 40 wt %, 10 to 30 wt %, 10 to 25 wt %, 20 to 75 wt %, 20 to 70 wt %, 20 to 60 wt %, 20 to 50 wt %, 20 to 40 wt %, 20 to 35 wt %, 20 to 30 wt %, 25 to 75 wt %, 25 to 70 wt %, 25 to 60 wt %, 25 to 50 wt %, 25 to 45 wt %, 25 to 40 wt %, or 25 to 35 wt %, based on the total weight of the composition, of the toughness modifier. In certain embodiments, the curable composition may comprise 25 to 35 wt %, based on the total weight of the composition, of the toughness modifier. In certain embodiments, the curable composition may comprise 20 to 40 wt %, based on the total weight of the composition, of the toughness modifier.

### 4) Glass Transition Temperature Modifiers

In some embodiments, the curable composition of the present disclosure may further comprise a glass transition temperature (T_{g}) modifier (also referred to herein as a T_{g} modifier). The T_{g} modifier can have a high glass transition temperature, which leads to a high heat deflection temperature, which can be necessary to use a material at elevated temperatures. The toughness modifier, the reactive diluent, and the T_{g} modifier are typically miscible and compatible in the methods described herein. When used in the subject compositions, the T_{g} modifier may provide for high T_{g} and strength values, sometimes at the expense of elongation at break. The toughness modifier may provide for high elongation at break and toughness via strengthening effects, and the reactive diluent may improve the processability of the formulations, particularly of those comprising high amounts of toughness modifiers, while maintaining high values for strength and T_{g}. The T_{g} modifier typically has a higher T_{g} than the toughness modifier.

In certain embodiments, the curable composition comprises 0 to 80 wt %, 0 to 75 wt %, 0 to 70 wt %, 0 to 65 wt %, 0 to 60 wt %, 0 to 55 wt %, 0 to 50 wt %, 1 to 50 wt %, 2 to 50 wt %, 3 to 50 wt %, 4 to 50 wt %, 5 to 50 wt %, 10 to 50 wt %, 15 to 50 wt %, 20 to 50 wt %, 25 to 50 wt %, 30 to 50 wt %, 35 to 50 wt %, 0 to 40 wt %, 1 to 40 wt %, 2 to 40 wt %, 3 to 40 wt %, 4 to 40 wt %, 5 to 40 wt %, 10 to 40 wt %, 15 to 40 wt %, or 20 to 40 wt % of a T_{g} modifier. In certain embodiments, the curable composition comprises 0-50 wt % of a glass transition modifier.

The T_{g} modifier can be a telechelic oligomer having a number average molecular weight ranging from 0.4 to 5 kDa. In certain embodiments, the number average molecular weight of the T_{g} modifier is from 0.4 to 5 kDa, 0.5 to 5 kDa, from 0.6 to 5 kDa, from 0.7 to 5 kDa, from 0.8 to 5 kDa, from 0.9 to 5 kDa, from 1.0 to 5 kDa, from 0.4 to 4 kDa, from 0.5 to 4 kDa, from 0.6 to 4 kDa, from 0.7 to 4 kDa, from 0.8 to 4 kDa, from 0.9 to 4 kDa, from 1 to 4 kDa, from 0.4 to 3 kDa, from 0.5 to 3 kDa, from 0.6 to 3 kDa, from 0.7 to 3 kDa, from 0.8 to 3 kDa, from 0.9 to 3 kDa, or from 1 to 3 kDa.

In certain embodiments, the T_{g} modifier may comprise a urethane group. In certain embodiments, the T_{g} modifier comprises at least one methacrylate group. In some embodiments, the T_{g} modifier is a polyester dimethacrylate oligomer or a polyurethane dimethacrylate oligomer. In some embodiments, the T_{g} is polyether modified polyurethane dimethacrylate. In certain embodiments, the T_{g} modifier is selected from H1188 (bis((2-((methacryloyloxy)methyl)octahydro-1H-4,7-methanoinden-5-yl)methyl) cyclohexane-1,4-dicarboxylate), TGM1, TGM2, TGM3, TGM4. In certain embodiments, the T_{g} modifier is a derivative of H1188 (DMI), TGM1, TGM2, TGM3, orTGM4. In certain embodiments, the T_{g} modifier is a blend of modifiers comprising H1188 (DMI), TGM1, TGM2, TGM3, or TGM4.

In some embodiments, the T_{g} modifier is H1188:

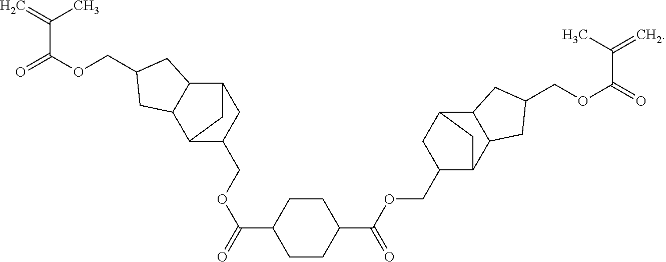 [SMILES: C=C(C)C(=O)OCC1CC2C3CC(COC(=O)C4CCC(C(=O)OCC5CC6CC5C5CC(COC(=O)C(=C)C)CC65)CC4)C(C3)C2C1]

In some embodiments, the T_{g} modifier is TGM1:

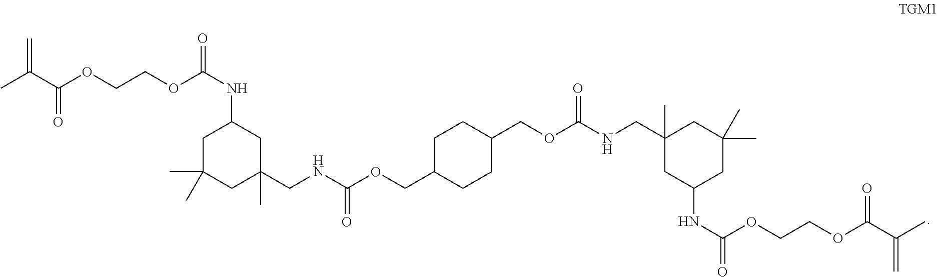 [SMILES: C=C(C)C(=O)OCCOC(=O)NC1CC(C)(C)CC(C)(CNC(=O)OCC2CCC(COC(=O)NCC3(C)CC(NC(=O)OCCOC(=O)C(=C)C)CC(C)(C)C3)CC2)C1]

In some embodiments, the T_{g} modifier is TGM2:

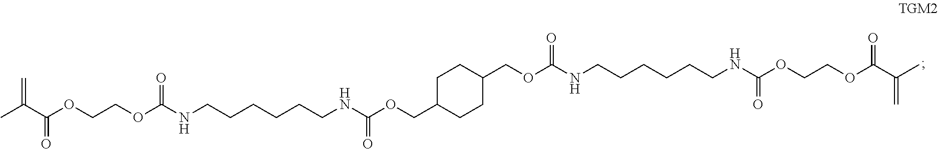 [SMILES: C=C(C)C(=O)OCCOC(=O)NCCCCCCNC(=O)OCC1CCC(COC(=O)NCCCCCCNC(=O)OCCOC(=O)C(=C)C)CC1]

In some embodiments, the T_{g} modifier is TGM3:

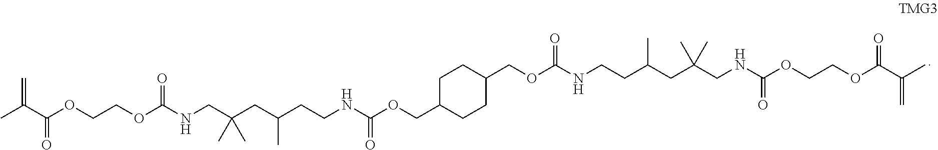 [SMILES: C=C(C)C(=O)OCCOC(=O)NCC(C)(C)CC(C)CCNC(=O)OCC1CCC(COC(=O)NCCC(C)CC(C)(C)CNC(=O)OCCOC(=O)C(=C)C)CC1]

In some embodiments, the T_{g} modifier is TGM4:

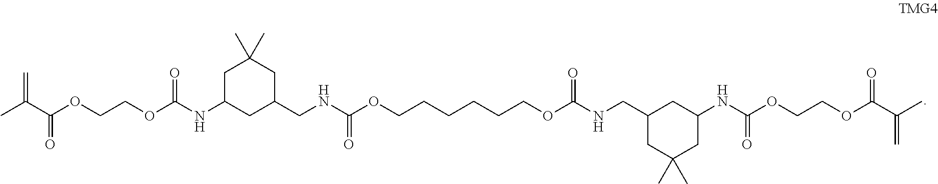 [SMILES: C=C(C)C(=O)OCCOC(=O)NC1CC(CNC(=O)OCCCCCCOC(=O)NCC2CC(NC(=O)OCCOC(=O)C(=C)C)CC(C)(C)C2)CC(C)(C)C1]

In some embodiments, the T_{g} modifier comprises a plurality of aliphatic rings. In certain embodiments, the T_{g} modifier comprises a plurality of aliphatic rings. In some aspects, the aliphatic rings are hydrocarbon rings. In some embodiments, the aliphatic rings are saturated. In some embodiments, the plurality of aliphatic rings comprises cyclobutane, cyclopentane, cyclohexane, cycloheptane, cyclooctane, cyclononane, cyclodecane, or any combination thereof. In some aspects, the plurality of aliphatic rings includes bridged ring structures. In some embodiments, the plurality of aliphatic rings includes fused ring structures. In certain embodiments, the middle portion of the T_{g} modifier comprises a cyclohexane-1,4-dicarboxylic acid, a cyclohexanedimethanol, a cyclohexane-1,4-diylbis(methylene) dicarbamate, or a combination thereof. In certain embodiments, the center of the Tg modifier structure comprises a cyclohexane-1,4-diylbis(methylene) dicarbamate (e.g., TGM1, TGM2, and TGM3).

In some embodiments, the T_{g} modifier comprises a methacrylate. In some embodiments, the T_{g} modifier comprises at least two methacrylates. In certain embodiments, the T_{g} modifier has terminal portions comprising methacrylates. In some embodiments, the T_{g} modifier has a structure that terminates at each end with a methacrylate. In some embodiments, the T_{g} modifier is a bis(2-methacrylate) (e.g., TGM1, TGM2, TGM3, TGM4, and H1188).

In some embodiments, the T_{g} modifier comprises a blend of components, selected from TGM1, TGM2, TGM3, TGM4, H1188, D3MA (1,10-decanediol dimethacrylate), D4MA (1,12-dodecanediol dimethacrylate), LPU624, a derivative thereof, or a combination thereof. In some embodiments, the Tg modifier comprises Bomar XR-741MS. The polymerization inhibitor-functionalized particles help to prevent undesired polymerization of the T_{g} modifier.

### 5) Initiators

In various embodiments, the curable composition disclosed herein is a photopolymerizable composition. In some embodiments, the curable composition comprises an initiator that is a photoinitiator. Such photoinitiator, when activated with light of an appropriate wavelength (e.g., UV/VIS) can initiate a polymerization reaction (e.g., during photo-curing) between the monomers, toughness modifiers, and other potentially polymerizable components that may be present in the photopolymerizable matrix, to form a polymeric material as further described herein. Generally, photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light). The polymerization inhibitor-functionalized particles help to prevent the decomposition of the photoinitiator in the unreacted portion of the resin composition during additive manufacturing.

In embodiments, the photoinitiator is a radical photoinitiator and/or a cationic initiator. In some embodiments, the photoinitiator is a Type I photoinitiator that undergoes a unimolecular bond cleavage to generate free radicals. In an additional embodiment, the photoinitiator is a Type II photoinitiator which undergoes a bimolecular reaction to generate free radicals. Common Type I photoinitiators include, but are not limited to benzoin ethers, benzil ketals, α-dialkoxy-acetophenones, α-hydroxy-alkyl phenones, and acyl-phosphine oxides. Common Type II photoinitiators include benzophenones/amines and thioxanthones/amines. Cationic initiators include aryldiazonium, diaryliodonium, and triarylsulfonium salts. In preferred embodiments, the photoinitiator comprises phenylbis(2,4,6-trimethylbenzoyl)phosphine oxide (BAPO), diphenyl-(2,4,6-trimethylbenzoyl)phosphine oxide (TPO), ethyl-(2,4,6-trimethylbenzoyl)phenylphosphinate (TPO-L), a polymeric TPO-L (Omnipol TP), alpha-hydroxyketone (Chivacure 300), benzil Dimethyl Ketal (BDK), or a combination thereof.

In some embodiments, the photoinitiator initiates photopolymerization using light energy. In certain embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm. In some embodiments, the photoinitiator initiates photopolymerization following the absorption of two photons, which can use longer wavelengths of light to initiate the photopolymerization.

In some embodiments, the curable composition comprises more than one initiator (e.g., 2, 3, 4, 5, or more than 5 initiators). In some embodiments, the curable composition comprises an initiator that is a thermal initiator. In certain embodiments, the thermal initiator comprises an organic peroxide. In some embodiments, the thermal initiator comprises an azo compound, an inorganic peroxide, an organic peroxide, or any combination thereof. In some embodiments, the thermal initiator is selected from the group consisting of tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 2,5-bis(tert-butylperoxy_2,5-dimethylhexane, 2,5-bis(tert-butylperoxy)-2,5-dimethyl-3-hexyne, bis(1-(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi(2-methylbutyronitrile), or a combination thereof.

In some embodiments, the curable composition comprises 0.01-10 wt %, 0.02-5 wt %, 0.05-4 wt %, 0.1-3 wt %, 0.1-2 wt %, or 0.1-1 wt %, based on the total weight of the composition, of the initiator. In preferred embodiments, the curable composition comprises 0.1-2 wt % of the initiator. In some embodiments, the curable composition comprises 0.01-10 wt %, 0.02-5 wt %, 0.05-4 wt %, 0.1-3 wt %, 0.1-2 wt %, or 0.1-1 wt % of the photoinitiator. In preferred embodiments, the curable composition comprises 0.1-2 wt % of the photoinitiator. In some embodiments, the curable composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt % of the thermal initiator. In preferred embodiments, the curable composition comprises from 0 to 0.5 wt % of the thermal initiator.

### 6) Additional Components

In some embodiments, a curable composition may further comprise additional components such as a crosslinking modifier, a polymerization catalyst, a light blocker, a plasticizer, a solvent, a surface energy modifier (e.g., a mold releasing agent), a pigment, a dye, a filler, a biologically significant chemical, or any combination thereof.

In some embodiments, the curable composition further comprises a crosslinking modifier. The crosslinking modifier may have a sufficient number of polymerizable groups to affect crosslinking. The crosslinking modifier may comprise at least two, at least three, at least four, at least five, or at least six polymerizable groups. The polymerizable groups can be acrylate, methacrylate, or epoxy groups. In some embodiments, the curable composition comprises 0 to 25 wt %, 0 to 20 wt %, 0 to 15 wt %, 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the crosslinking modifier.

In some embodiments, the curable composition further comprises a polymerization catalyst. In some embodiments, the polymerization catalyst comprises a tin catalyst, a platinum catalyst, a rhodium catalyst, a titanium catalyst, a silicon catalyst, a palladium catalyst, a metal triflate catalyst, a boron catalyst, a bismuth catalyst, or any combination thereof. Non-limiting examples of a titanium catalyst include di-n-butylbutoxychlorotin, di-n-butyldiacetoxytin, di-n-butyldilauryltin, dimethyldineodecanoatetin, dioctyldilauryltin, tetramethyltin, and dioctylbis(2-ethylhexylmaleate)tin. Non-limiting examples of a platinum catalyst include platinum-divinyltetramethyl-disiloxane complex, platinum-cyclovinylmethyl-siloxane complex, platinum-octanal complex, and platinum carbonyl cyclovinylmethylsiloxane complex. A non-limiting example of a rhodium catalyst includes tris(dibutylsulfide)rhodium trichloride. Non-limiting examples of a titanium catalyst includes titanium isopropoxide, titanium 2-ethyl-hexoxide, titanium chloride triisopropoxide, titanium ethoxide, and titanium diisopropoxide bis(ethylacetoacetate). Non-limiting examples of a silicon catalyst include tetramethylammonium siloxanolate and tetramethylsilylmethyl-trifluoromethanesulfonate. A non-limiting example of a palladium catalyst includes tetrakis(triphenylphosphine)palladium(0). Non-limiting examples of a metal triflate catalyst include scandium trifluoromethanesulfonate, lanthanum trifluoromethanesulfonate, and ytterbium trifluoromethanesulfonate. A non-limiting example of a boron catalyst includes tris(pentafluorophenyl)boron. Non-limiting examples of a bismuth catalyst include bismuth-zinc neodecanoate, bismuth 2-ethylhexanoate, a metal carboxylate of bismuth and zinc, and a metal carboxylate of bismuth and zirconium. In some embodiments, the curable composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the polymerization catalyst.

In some embodiments, the curable composition further comprises a light blocker. The light blocker can absorb irradiation and prevent or decrease the rate of polymerization or degradation, and its addition to the polymerizable composition can increase the resolution of printable materials. In certain embodiments, the light blocker comprises a hydroquinone, 1,4-dihydroxybenzene, a compound belonging to the HALS (hindered-amine light stabilizer) family, a benzophenone, a benzotriazole, any derivative thereof, or any combination thereof. In some embodiments, the light blocker comprises 2,2′-dihydroxy-4-methoxybenzophenone. In certain embodiments, the light blocker is selected from the group consisting of Michler's ketone, 4-Allyloxy-2-hydroxybenzophenone 99%, 2-(2H-benzotriazol-2-yl)-4,6-bis(1-methyl-1-phenylethyl)phenol powder, 2-(2H-benzotriazol-2-yl)-4,6-di-tert-pentylphenol, 2-(2H-benzotriazol-2-yl)-6-dodecyl-4-methylphenol, 2-(3-(2H-benzotriazol-2-yl)-4-hydroxyphenyl)ethyl methacrylate, 2-(2H-benzotriazol-2-yl)-4-methyl-6-(2-propenyl)phenol, 2-(2H-benzotriazol-2-yl)-4-(1,1,3,3-tetramethylbutyl)phenol, 2-(4-benzoyl-3-hydroxyphenoxy)ethyl acrylate, 3,9-bis(2,4-dicumylphenoxy)-2,4,8,10-tetraoxa-3,9-diphosphaspiro[5.5]undecane, bis(octadecyl)hydroxylamine powder, 3,9-bis(octadecyloxy)-2,4,8,10-tetraoxa-3,9-diphosphaspiro[5.5]undecane, bis(1-octyloxy-2,2,6,6-tetramethyl-4-piperidyl) sebacate, bis(2,2,6,6-tetramethyl-4-piperidyl) sebacate, 2-tert-butyl-6-(5-chloro-2H-benzotriazol-2-yl)-4-methylphenol, 2-tert-Butyl-4-ethylphenol, 5-chloro-2-hydroxybenzophenone, 5-chloro-2-hydroxy-4-methylbenzophenone, 2,4-di-tert-butyl-6-(5-chloro-2H-benzotriazol-2-yl)phenol, 2,6-di-tert-butyl-4-(dimethylaminomethyl)phenol, 3′,5′-dichloro-2′-hydroxyacetophenone, didodecyl 3,3′-thiodipropionate, 2,4-dihydroxybenzophenone, 2,2′-dihydroxy-4-methoxybenzophenone, 2′,4′-dihydroxy-3′-propylacetophenone, 2,3-dimethylhydroquinone, 2-(4,6-diphenyl-1,3,5-triazin-2-yl)-5-((hexyl)oxy)-phenol, 5-ethyl-1-aza-3,7-dioxabicyclo[3.3.0]octane, ethyl 2-cyano-3,3-diphenylacrylate, 2-ethylhexyl 2-cyano-3,3-diphenylacrylate, 2-ethylhexyl trans-4-methoxycinnamate, 2-ethylhexyl salicylate, 2-hydroxy-4-(octyloxy)benzophenone, methyl anthranilate, 2-methoxyhydroquinone, methyl-p-benzoquinone, 2,2′-methylenebis(6-(2H-benzotriazol-2-yl)-4-(1,1,3,3-tetramethylbutyl)pheno)), 2,2′-methylenebis(6-tert-butyl-4-ethylphenol), 2,2′-methylenebis(6-tert-butyl-4-methylphenol), 5,5′-methylenebis(2-hydroxy-4-methoxybenzophenone), methylhydroquinone, 4-nitrophenol sodium salt hydrate, octadecyl 3-(3,5-di-tert-butyl-4-hydroxyphenyl)propionate, pentaerythritol tetrakis(3,5-di-tert-butyl-4-hydroxyhydrocinnamate), 2-phenyl-5-benzimidazolesulfonic acid, poly((6-((1,1,3,3-tetramethylbutyl)amino)-s-triazine-2,4-diyl)-((2,2,6,6-tetramethyl-4-piperidyl)imino)-hexamethylene-((2,2,6,6-tetramethyl-4-piperidyl)imino), sodium d-isoascorbate monohydrate, tetrachloro-1,4-benzoquinone, triisodecyl phosphite, 1,3,5-trimethyl-2,4,6-tris(3,5-di-tert-butyl-4-hydroxybenzyl)benzene, tris(4-tert-butyl-3-hydroxy-2,6-dimethylbenzyl) isocyanurate, tris(2,4-di-tert-butylphenyl) phosphite, 1,3,5-tris(2-hydroxyethyl)isocyanurate, and tris(nonylphenyl) phosphite. In some embodiments, the light blocker comprises 2-(2′-hydroxy-phenyl benzotriazole), 2,2′-dihydroxy-4-methoxybenzophenone, 9,10-diethoxyanthracene, a hydroxyphenyltriazine, an oxanilide, a benzophenone, or a combination thereof.

In some embodiments, the light blocker has a maximum wavelength absorbance between 200 and 300 nm, between 300 and 400 nm, between 400 and 500 nm, between 500 and 600 nm, between 600 and 700 nm, between 700 and 800 nm, between 800 and 900 nm, between 150 and 200 nm, between 200 and 250 nm, between 250 and 300 nm, between 300 and 350 nm, between 350 and 400 nm, between 400 and 450 nm, between 450 and 500 nm, between 500 and 550 nm, between 550 and 600 nm, between 600 and 650 nm, between 650 and 700 nm, or between 700 and 750 nm. In some embodiments, the light blocker has a maximum wavelength absorbance between 300 to 500 nm, such as 300 to 400 nm or 350 to 480 nm. In some embodiments, the light block is a UV blocker absorbing light in the UV region.

In some embodiments, the curable composition comprises from 0 to 20 wt %, 0 to 15 wt %, 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the light blocker. In preferred embodiments, the curable composition comprises from 0.01 to 10 wt % of the light blocker.

In some embodiments, the curable composition further comprises a filler. In some embodiments, the filler comprises calcium carbonate (i.e., chalk), kaolin, metakolinite, a kaolinite derivative, magnesium hydroxide (i.e., talc), calcium silicate (i.e., wollastonite), a glass filler (e.g., glass particles, short glass fibers, or long glass fibers), a nanofiller (e.g., nanoplates, nanofibers, or nanoparticles), a silica filler (e.g., a mica, silica gel, fumed silica, or precipitated silica), carbon black, dolomite, barium sulfate, ATH Al(OH)₃, MDH Mg(OH)₂, diatomaceous earth, magnetite, halloysite, zinc oxide, titanium dioxide, cellulose, lignin, a carbon filler (e.g., chopped carbon fiber or carbon fiber), a derivative thereof, or a combination thereof.

In some embodiments, the curable composition further comprises a pigment, a dye, or a combination thereof. A pigment is typically a suspended solid that may be insoluble in the resin. A dye is typically dissolved in the curable composition. In some embodiments, the pigment comprises an inorganic pigment. In some embodiments, the inorganic pigment comprises an iron oxide, barium sulfide, zinc oxide, antimony trioxide, a yellow iron oxide, a red iron oxide, ferric ammonium ferrocyanide, chrome yellow, carbon black, or aluminum flake. In some embodiments, the pigment comprises an organic pigment. In some embodiments, the organic pigment comprises an azo pigment, an anthraquinone pigment, a copper phthalocyanine (CPC) pigment (e.g., phthalo blue or phthalo green), or a combination thereof. In some embodiments, the dye comprises an azo dye (e.g., a diarylide or Sudan stain), an anthraquinone (e.g., Oil Blue A or Disperse Red 11), or a combination thereof.

In some embodiments, the curable composition further comprises a surface energy modifier. In some embodiments, the surface energy modifier can aid the process of releasing a polymer from a mold. In some embodiments, the surface energy modifier can act as an antifoaming agent. In some embodiments, the surface energy modifier comprises a defoaming agent, a deaeration agent, a hydrophobization agent, a leveling agent, a wetting agent, or an agent to adjust the flow properties of the curable composition. In some embodiments, the surface energy modifier comprises an alkoxylated surfactant, a silicone surfactant, a sulfosuccinate, a fluorinated polyacrylate, a fluoropolymer, a silicone, a star-shaped polymer, an organomodified silicone, or any combination thereof.

In some embodiments, the curable composition further comprises a plasticizer. A plasticizer can be a nonvolatile material that can reduce interactions between polymer chains, which can decrease glass transition temperature, melt viscosity, and elastic modulus. In some embodiments, the plasticizer comprises a dicarboxylic ester plasticizer, a tricarboxylic ester plasticizer, a trimellitate, an adipate, a sebacate, a maleate, or a bio-based plasticizer. In some embodiments, the plasticizer comprises a dicarboxylic ester or a tricarboxylic ester comprising a dibasic ester, a phthalate, bis(2-ethylhexyl) phthalate (DEHP), bis(2-propylheptyl) phthalate (DPHP), diisononyl phthalate (DINP), di-n-butyl phthalate (DBP), butyl benzyl phthalate (BBzP), diisodecyl phthalate (DIDP), dioctyl phthalate (DOP), diisooctyl phthalate (DIOP), diethyl phthalate (DEP), diisobutyl phthalate (DIBP), di-n-hexyl phthalate, a derivative thereof, or a combination thereof. In some embodiments, the plasticizer comprises a trimellitate comprising trimethyl trimellitate (TMTM), tri-(2-ethylhexyl) trimellitate (TEHTM), tri-(n-octyl,n-decyl) trimellitate (ATM), tri-(heptyl,nonyl) trimellitate (LTM), n-octyl trimellitate (OTM), trioctyl trimellitate, a derivative thereof, or a combination thereof. In some embodiments, the plasticizer comprises an adipate comprising bis(2-ethylhexyl)adipate (DEHA), dimethyl adipate (DMAD), monomethyl adipate (MMAD), dioctyl adipate (DOA), bis(2-(2-butoxyethoxy)ethyl) adipate, dibutyl adipate, diisobutyl adipate, diisodecyl adipate, a derivative thereof, or a combination thereof. In some embodiments, the plasticizer comprises a sebacate comprising dibutyl sebacate (DBS), bis(2-ethylhexyl) sebacate, diethyl sebacate, dimethyl sebacate, a derivative thereof, or a combination thereof. In some embodiments, the plasticizer comprises a maleate comprising bis(2-ethylhexyl) maleate, dibutyl maleate, diisobutyl maleate, a derivative thereof, or a combination thereof. In some embodiments, the plasticizer comprises a bio-based plasticizer comprising an acetylated monoglyceride, an alkyl citrate, a methyl ricinoleate, or a green plasticizer. In some embodiments, the alkyl citrate is selected from the group consisting of triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, a derivative thereof, or a combination thereof. In some embodiments, the green plasticizer is selected from the group consisting of epoxidized soybean oil, epoxidized vegetable oil, epoxidized esters of soybean oil, a derivative thereof, or a combination thereof. In some embodiments, the plasticizer comprises an azelate, a benzoate (e.g., sucrose benzoate), a terephthalate (e.g., dioctyl terephthalate), 1,2-cyclohexane dicarboxylic acid diisononyl ester, alkyl sulphonic acid phenyl ester, a sulfonamide (e.g., N-ethyl toluene sulfonamide, N-(2-hydroxypropyl) benzene sulfonamide, N-(n-butyl) benzene sulfonamaide), an organophosphate (e.g., tricresyl phosphate or tributyl phosphate), a glycol (e.g., triethylene glycol dihexanoate or tetraethylene glycol diheptanoate), a polyether, a polymeric plasticizer, polybutene, a derivative thereof, or a combination thereof.

In some embodiments, the curable composition further comprises a solvent. In some embodiments, the solvent comprises a nonpolar solvent. In certain embodiments, the nonpolar solvent comprises pentane, cyclopentane, hexane, cyclohexane, benzene, toluene, 1,4-dioxane, chloroform, diethyl ether, dichloromethane, a derivative thereof, or a combination thereof. In some embodiments, the solvent comprises a polar aprotic solvent. In certain embodiments, the polar aprotic solvent comprises tetrahydrofuran, ethyl acetate, acetone, dimethylformamide, acetonitrile, DMSO, propylene carbonate, a derivative thereof, or a combination thereof. In some embodiments, the solvent comprises a polar protic solvent. In certain embodiments, the polar protic solvent comprises formic acid, n-butanol, isopropyl alcohol, n-propanol, t-butanol, ethanol, methanol, acetic acid, water, a derivative thereof, or a combination thereof. In preferred embodiments, the curable composition comprises less than 90 wt %, based on the total weight of the composition, of the solvent.

In some embodiments, the curable composition further comprises a biologically significant chemical. In some embodiments, the biologically significant chemical comprises a hormone, an enzyme, an active pharmaceutical ingredient, an antibody, a protein, a drug, or any combination thereof. In some embodiments, the biologically significant chemical comprises a pharmaceutical composition, a chemical, a gene, a polypeptide, an enzyme, a biomarker, a dye, a compliance indicator, an antibiotic, an analgesic, a medical grade drug, a chemical agent, a bioactive agent, an antibacterial, an antibiotic, an anti-inflammatory agent, an immune-suppressive agent, an immune-stimulatory agent, a dentinal desensitizer, an odor masking agent, an immune reagent, an anesthetic, a nutritional agent, an antioxidant, a lipopolysaccharide complexing agent or a peroxide.

In some embodiments, the added component (e.g., a crosslinking modifier, a polymerization catalyst, a light blocker, a plasticizer, a solvent, a surface energy modifier, a pigment, a dye, a filler, or a biologically significant chemical) is functionalized so that it can be incorporated into the polymer network so that it cannot readily be extracted from the final cured material. In certain embodiments, the polymerization catalyst, light blocker, plasticizer, surface energy modifier, pigment, dye, and/or filler are functionalized to facilitate their incorporation into the cured polymeric material. A polymer network, as used herein, can refer to a polymer composition comprising a plurality of polymer chains wherein a large portion (e.g., >80%) and optionally all the polymer chains are interconnected, for example via covalent crosslinking, to form a single polymer composition. In an embodiment, there is provided a radiopaque polymer in the form of a crosslinked network in which at least some of the crosslinks of the network structure are formed by covalent bonds.

### Curable Composition Properties

Curable compositions of the present disclosure can be characterized by one or more properties. In some embodiments, a curable composition can have a viscosity from about 30 cP to about 50,000 cP at a printing temperature. In some embodiments, the curable composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. In some embodiments, the curable composition has a viscosity less than 15,000 cP at 25° C. In some embodiments, the curable composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the curable composition has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C.

The curable composition of the present disclosure can be capable of being 3D printed at a temperature greater than 25° C. In some cases, the printing temperature is at least about 30° C., 40° C., 50° C., 60° C., 80° C., or 100° C. As described herein, a reactive diluent of this disclosure can have a low vapor pressure and/or mass loss at the printing temperature, thereby providing improved printing conditions compared to conventional compositions used in additive manufacturing.

In some embodiments, the curable composition herein has a melting temperature greater than room temperature. In some embodiments, the curable composition has a melting temperature greater than 20° C., greater than 25° C., greater than 30° C., greater than 35° C., greater than 40° C., greater than 45° C., greater than 50° C., greater than 55° C., greater than 60° C., greater than 65° C., greater than 70° C., greater than 75° C., or greater than 80° C. In some embodiments, the curable composition has a melting temperature from 20° C. to 250° C., from 30° C. to 180° C., from 40° C. to 160° C., or from 50° C. to 140° C. In some embodiments, the curable composition has a melting temperature greater than 60° C. In other embodiments, the curable composition has a melting temperature from 80° C. to 110° C. In some instances, a curable composition can have a melting temperature of about 80° C. before polymerization, and after polymerization, the resulting polymeric material can have a melting temperature of about 100° C.

In certain instances, it may be advantageous that the curable composition is in a liquid phase at an elevated temperature. As an example, a conventional curable composition can comprise polymerizable components that may be viscous at a process temperature, and thus can be difficult to use in the fabrication of objects (e.g., using 3D printing). As a solution for that technical problem, the present disclosure provides curable composition comprising photopolymerizable components such as monomers described herein that can melt at an elevated temperature, e.g., at a temperature of fabrication (e.g., during 3D printing), and can have a decreased viscosity at the elevated temperature, which can make such polymerizable compositions more applicable and usable for uses such as 3D printing. Hence, in some embodiments, provided herein are curable composition that are a liquid at an elevated temperature. In some embodiments, the elevated temperature is at or above the melting temperature (Tm) of the curable compositions. In certain embodiments, the elevated temperature is a temperature in the range from about 40° C. to about 100° C., from about 60° C. to about 100° C., from about 80° C. to about 100° C., from about 40° C. to about 150° C., or from about 150° C. to about 350° C. In some embodiments, the elevated temperature is a temperature above about 40° C., above about 60° C., above about 80° C., or above about 100° C. In some embodiments, the curable composition herein is a liquid at an elevated temperature with a viscosity less than about 50 Pa·s, less than 2 about 0 Pa·s, less than about 10 Pa·s, less than about 5 Pa·s, or less than about 1 Pa·s. In some embodiments, the curable composition herein is a liquid at an elevated temperature of above about 40° C. with a viscosity less than about 20 Pa·s. In yet other embodiments, a curable composition herein is a liquid at an elevated temperature of above about 40° C. with a viscosity less than about 1 Pa·s.

In some embodiments, at least a portion of the curable composition herein has a melting temperature below about 100° C., below about 90° C., below about 80° C., below about 70° C., or below about 60° C. In some embodiments, at least a portion of a curable composition herein melts at an elevated temperature between about 100° C. and about 20° C., between about 90° C. and about 20° C., between about 80° C. and about 20° C., between about 70° C. and about 20° C., between about 60° C. and about 20° C., between about 60° C. and about 10° C., or between about 60° C. and about 0° C.

The curable composition of the present disclosure can comprise less than about 20 wt % or less than about 10 wt % hydrogen bonding units. In some embodiments, a curable composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units.

In various embodiments, the curable composition herein as well as its photopolymerizable components can be biocompatible, bioinert, or a combination thereof. In various instances, the photopolymerizable compounds of a composition herein can have biocompatible and/or bioinert metabolic (e.g., hydrolysis) products.

### Polymeric Materials

In some embodiments, the present disclosure provides polymeric materials formed from the curable compositions disclosed herein. In preferred embodiments, the polymeric material is formed from the curable compositions disclosed herein with additive manufacturing. In some embodiments, the polymeric material is prepared by a process comprising: providing a curable composition as described herein; and forming the polymeric material from the curable composition with additive manufacturing. In some preferred embodiments, the polymeric material is prepared by a process comprising: providing a curable composition comprising: an oligomer having a number-average molecular weight of greater than 3,000 Da, a reactive diluent, polymerization inhibitor-functionalized particles, and an initiator, wherein the curable composition comprises less than 20 wt % hydrogen bonding units and has a viscosity less than or equal to 15,000 cP at 25° C.; and forming the polymeric material from the curable composition with additive manufacturing. In certain preferred embodiments, the polymeric material is prepared by a process comprising: providing a curable composition comprising: an oligomer having a number-average molecular weight of greater than 3,000 Da; a reactive diluent; polymerization inhibitor-functionalized particles; and a photoinitiator, wherein the curable composition comprises less than 10 wt % hydrogen bonding units; and forming the polymeric material from the curable composition with additive manufacturing.

In some embodiments, the present disclosure provides a polymeric material having less than 10 wt % hydrogen bonding units, wherein the polymeric material is characterized by one or more of: a tensile modulus greater than or equal to 200 MPa after 24 hours in a wet environment at 37° C.; a flexural stress of greater than or equal to 1.5 MPa remaining after 24 hours in a wet environment at 37° C.; a hardness from 60 Shore A to 85 Shore D after 24 hours in a wet environment at 37° C.; an elongation at break greater than or equal to 15% before 24 hours in a wet environment at 37° C.; and an elongation at break greater than or equal to 15% after 24 hours in a wet environment at 37° C. In preferred embodiments, the polymeric material is formed from the curable compositions disclosed herein. Young's modulus is calculated with an algorithm that breaks the relevant portion of a stress strain curve into 6 regions with 0% overlap and applies a least square fitting to determine the slope. The pair of consecutive regions that have the highest slope sum are determined. From this pair, the modulus is assigned to the region with the highest slope.

Property values of the polymeric material can be determined, for example, by using the following methods:
stress relaxation properties can be assessed using an RSA-G2 instrument from TA Instruments, with a 3-point bending, according to ASTM D790; stress relaxation can be measured at 30° C. and submerged in water, and reported as either the remaining load after 24 hours, and/or as the percent (%) of initial load;
storage modulus can be measured at 37° C. and is reported in MPa;
T_{g} of the cured polymeric material can be assessed using dynamic mechanical analysis (DMA) and is provided herein as the tan δ peak when run at 1 Hz with a temperature ramp of 2° C. a minute;
tensile modulus, tensile strength, elongation at yield and elongation at break can be assessed according to ISO 527-2 5B;
tensile strength at yield, elongation at break, tensile strength, and Young's modulus can be assessed according to ASTM D1708 or ASTM D638; and
flexural stress remaining after 24 hours in wet environment at 37° C. (“flexural stress remaining”) can be assessed according to ASTM E328.

In some embodiments, the polymeric material is characterized by a tensile stress-strain curve that displays a yield point after which the test specimen continues to elongate, but there is no increase in load. Such yield point behavior typically occurs “near” the glass transition temperature, where the material is between the glassy and rubbery regimes and may be characterized as having viscoelastic behavior. In embodiments, viscoelastic behavior is observed in the temperature range 20° C. to 40° C. The yield stress is determined at the yield point. In some embodiments, the yield point follows an elastic region in which the slope of the stress-strain curve is constant or nearly constant. In embodiments, the modulus is determined from the initial slope of the stress-strain curve or as the secant modulus at 1% strain (e.g., when there is no linear portion of the stress-strain curve). The elongation at yield is determined from the strain at the yield point. When the yield point occurs at a maximum in the stress, the ultimate tensile strength is less than the yield strength. For a tensile test specimen, the strain is defined by 1n (1/1₀), which may be approximated by (1−1₀)/1₀ at small strains (e.g. less than approximately 10%) and the elongation is 1/1₀, where 1 is the gauge length after some deformation has occurred and 1₀ is the initial gauge length. The mechanical properties can depend on the temperature at which they are measured. The test temperature may be below the expected use temperature for a dental appliance such as 35° C. to 40° C. In some embodiments, the test temperature is 23±2° C.

Properties of the polymeric material can be determined after a soak time in a wet environment. Determination of values after a soak time in a wet environment can be conducted on a 1-mm thick sample. For example, material properties of a polymeric material disclosed herein can be determined by obtaining a 1-mm thick sample of said polymeric material, and soaking it in a wet environment for 24 hours at 37° C. (i.e., the material after 24 hours in a wet environment at 37° C.).

In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material has an elongation at break greater than 15% before and after 24 hours in a wet environment at 37° C.

In some embodiments, the polymeric material has a tensile strength at yield from 1 MPa to 100 MPa, from 5 MPa to 85 MPa, from 10 MPa to 75 MPa, from 15 MPa to 65 MPa, from 20 MPa to 55 MPa, or from 25 MPa to 45 MPa after 24 hours in a wet environment at 37° C. In preferred embodiments, the polymeric material has a tensile strength at yield from 10 MPa to 55 MPa after 24 hours in a wet environment at 37° C. In some embodiments, the polymeric material is characterized by a tensile strength at yield greater than or equal to 0.1 MPa, greater than or equal to 0.5 MPa, greater than or equal to 1 MPa, greater than or equal to 2 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, or greater than or equal to 10 MPa after 24 hours in a wet environment at 37° C. In preferred embodiments, the polymeric material is characterized by a tensile strength at yield greater than or equal to 5 MPa after 24 hours in a wet environment at 37° C.

In some embodiments, the polymeric material has an ultimate tensile strength from 10 MPa to 100 MPa, from 15 MPa to 80 MPa, from 20 MPa to 60 MPa, from 25 MPa to 50 MPa, from 25 MPa to 45 MPa, from 25 MPa to 40 MPa, from 30 MPa to 45 MPa, or from 30 MPa to 40 MPa after 24 hours in a wet environment at 37° C. In preferred embodiments, the polymeric material has an ultimate tensile strength from 10 MPa to 50 MPa after 24 hours in a wet environment at 37° C.

In some embodiments, the polymeric material has a tensile modulus from 100 MPa to 3000 MPa, from 200 MPa to 3000 MPa, from 250 MPa to 2750 MPa, from 400 MPa to 2500 MPa, from 600 MPa to 2250 MPa, or from 800 MPa to 2000 MPa after 24 hours in a wet environment at 37° C. In some embodiments, the polymeric material has a tensile modulus of greater or equal to 100 MPa, greater or equal to 200 MPa, greater or equal to 300 MPa, greater or equal to 400 MPa, greater or equal to 500 MPa, greater or equal to 600 MPa, greater or equal to 700 MPa, greater or equal to 800 MPa, greater or equal to 900 MPa, greater or equal to 1000 MPa, greater or equal to 1100 MPa, greater or equal to 1200 MPa, greater or equal to 1300 MPa, greater or equal to 1400 MPa, or greater or equal to 1500 MPa after 24 hours in a wet environment at 37° C. In some preferred embodiments, the polymeric material has a tensile modulus of greater than 200 MPa after 24 hours in a wet environment at 37° C. In some preferred embodiments, the polymeric material has a tensile modulus from 1.0 GPa to 1.4 GPa after 24 hours in a wet environment at 37° C. In some preferred embodiments, the polymeric material is characterized by a tensile modulus greater than or equal to 200 MPa after 24 hours in a wet environment at 37° C.

In some embodiments, the polymeric material has a flexural stress relaxation remaining (“flexural stress remaining”) greater than or equal to 5%, greater than or equal to 10%, greater than or equal to 15%, greater than or equal to 20%, greater than or equal to 35%, greater than or equal to 40%, greater than or equal to 45%, greater than or equal to 50%, greater than or equal to 55%, or greater than or equal to 60% after 24 hours in a wet environment at 37° C. In some preferred embodiments the polymeric material has a flexural stress remaining of greater than or equal to 10% after 24 hours in a wet environment at 37° C. In some embodiments, the polymeric material is characterized by a flexural stress remaining from 5% to 45%, from 10% to 45%, from 15% to 45%, from 20% to 45%, from 25% to 45%, or from 30% to 45% of the initial load after 24 hours in a wet environment at 37° C. In some preferred embodiments, the polymeric material is characterized by a flexural stress remaining from 20% to 45% of the initial load after 24 hours in a wet environment at 37° C.

In some embodiments, the polymeric material is characterized by a flexural stress remaining from 0.01 MPa to 15 MPa, from 0.05 MPa to 15 MPa, from 0.1 MPa to 15 MPa, from 0.5 MPa to 15 MPa, from 1 MPa to 15 MPa, from 2 MPa to 15 MPa, from 3 MPa to 15 MPa, from 4 MPa to 15 MPa, from 5 MPa to 15 MPa, or from 10 MPa to 15 MPa after 24 hours in a wet environment at 37° C. In some preferred embodiments, the polymeric material is characterized by a flexural stress remaining from 2 MPa to 15 MPa after 24 hours in a wet environment at 37° C. In some embodiments, the polymeric material is characterized by a flexural stress of greater than or equal to 0.1 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, greater than or equal to 10 MPa, or greater than or equal to 15 MPa remaining after 24 hours in a wet environment at 37° C. In some preferred embodiments, the polymeric material is characterized by a flexural stress of greater than or equal to 1.5 MPa remaining after 24 hours in a wet environment at 37° C.

In certain embodiments, it is advantageous that the polymeric materials have a high flexural stress remaining, forming relatively stiff materials. In some applications relating to use of hard materials (e.g., aeronautical engineering, medical implants), a polymeric material formed from the curable compositions disclosed herein would be advantageous due to the availability of conventional 3D printers to form these polymeric materials having the desired characteristics. In some embodiments, the polymeric material has a flexural modulus remaining of 50 MPa or more, 60 MPa or more, 70 MPa or more, 80 MPa or more, 90 MPa or more, 100 MPa or more, 125 MPa or more, or 150 MPa or more after 24 hours in a wet environment at 37° C.

In certain other embodiments, it is advantageous that the polymeric materials have a relatively low flexural stress remaining, forming materials that are not overly stiff. In some embodiments, the polymeric material has a flexural modulus remaining of 80 MPa or less, 70 MPa or less, 60 MPa or less, 55 MPa or less, 50 MPa or less, or 45 MPa or less after 24 hours in a wet environment at 37° C.

In some embodiments, a polymeric material will have a flexural stress remaining after a period of time of use. As a non-limiting example, an orthodontic appliance (e.g., an aligner) can be formed of a polymeric material having a high flexural stress. In some embodiments, following application of the appliance to the teeth of a patient, there can be a significant and fast decrease of flexural stress (e.g., over the course of minutes). Such decreases in flexural stress can follow an exponential curve of decrease leading towards an asymptote during the intended lifetime of the appliance (e.g., over the course of weeks for an orthodontic appliance such as an aligner). Orthodontic appliances may have an initial period of discomfort that, following a period of use, decreases corresponding with a decrease of flexural stress remaining. In some embodiments, the polymeric material has a flexural stress remaining of 90 MPa or less, 85 MPa or less, 80 MPa or less, 75 MPa or less, 70 MPa or less, 65 MPa or less, 60 MPa or less, 55 MPa or less, or 50 MPa or less after a time period of use. In preferred embodiments, the polymeric material has a flexural stress remaining of 80 MPa or less after a time period of use. In some embodiments, the time period of use is 1 minute, 5 minutes, 10 minutes, 30 minutes, 1 hour, or 24 hours. As a non-limiting example, an aligner composed of polymeric material placed onto a patient's teeth that is removed after 10 minutes and has a flexural stress of 70 MPa would have a polymeric material characterized by a flexural stress remaining of 70 MPa after a time period of use, wherein said time period is 10 minutes.

In certain embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% after 24 hours in a wet environment at 37° C. (i.e., following exposure to a wet environment for 24 hours). In some embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% before 24 hours in a wet environment at 37° C. In preferred embodiments, the polymeric material is characterized by an elongation at yield of greater than or equal to 4% before and after 24 hours in a wet environment at 37° C.

In some embodiments, the polymeric material has a maximum force at 5% strain greater than or equal to 3 pound-force per 3.57 cm². As a non-limiting example, the sample is a rectangular slab having a width of 2.1 cm and a distance between support of 1.7 cm. In some embodiments, the polymeric material has a remaining force greater than 0.1 pound-force per 3.57 cm² after being submerged for 24 hours in a wet environment having a temperature of 37° C.

In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% after 24 hours in a wet environment at 37° C. In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% before 24 hours in a wet environment at 37° C. In preferred embodiments, the polymeric material is characterized by an elongation at yield from 4% to 10% before and after 24 hours in a wet environment at 37° C.

In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material is characterized by an elongation at break of greater than 15% before and after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% before 24 hours in a wet environment at 37° C. In preferred embodiments, the polymeric material is characterized by an elongation at break from 40% to 250% before and after 24 hours in a wet environment at 37° C.

In some embodiments, the polymeric material is characterized by a storage modulus from 0.1 MPa to 4000 MPa, from 50 MPa to 2750 MPa, from 100 MPa to 2500 MPa, from 200 MPa to 2250 MPa, from 300 MPa to 3000 MPa, from 500 MPa to 3000 MPa, from 750 MPa to 3000 MPa, or from 1000 MPa to 3000 MPa after 24 hours in a wet environment at 37° C. In preferred embodiments, the polymeric material is characterized by a storage modulus from 750 MPa to 3000 MPa after 24 hours in a wet environment at 37° C.

In some embodiments, the polymeric material has at least one glass transition temperature (T_{g}) from 0° C. to 150° C. In some embodiments, the polymeric material has at least one glass transition temperature greater than 25° C., for example, 27° C. In some embodiments, the polymeric material has at least one glass transition temperature greater than 60° C. In some embodiments, the polymeric material has at least one glass transition temperature greater than 75° C. In some embodiments, the at least one glass transition temperature is from 0° C. to 200° C., from 0° C. to 140° C., from 0° C. to 20° C., from 20° C. to 40° C., from 40° C. to 60° C., from 60° C. to 80° C., from 80° C. to 100° C., from 100° C. to 120° C., from 120° C. to 140° C., from 140° C. to 160° C., from 160° C. to 180° C., from 180° C. to 200° C., from 0° C. to 35° C., from 35° C. to 65° C., from 65° C. to 100° C., from 0° C. to 50° C., or from 50° C. to 100° C. In some embodiments, the polymeric material has at least one glass transition temperature from 0° C. to 10° C., from 10° C. to 20° C., from 20° C. to 30° C., from 30° C. to 40° C., from 40° C. to 50° C., from 50° C. to 60° C., from 60° C. to 70° C., from 70° C. to 80° C., or from 80° C. to 90° C. In some embodiments, the polymeric material has at least one glass transition temperature from −100° C. to 40° C., from −80° C. to 10° C., from −70° C. to 0° C., from −70° C. to −10° C., from −70° C. to −20° C., from −70° C. to −30° C., from −70° C. to −40° C., from −70° C. to −50° C., or from −80° C. to −40° C. In some embodiments, the polymeric material has at least two glass transition temperatures. In certain embodiments, the polymeric material has a first glass transition temperature less than or equal to 40° C. and a second glass transition temperature greater than or equal to 60° C. In some embodiments, the polymeric material has a first glass transition temperature less than or equal to 0° C. and a second glass transition temperature greater than or equal to 60° C. In some embodiments, the polymeric material has a first glass transition temperature less than or equal to 0° C. and a second glass transition temperature greater than or equal to 75° C. In some embodiments, the polymeric material has a first glass transition temperature less than −20° C. and a second glass transition temperature greater than 80° C.

In some embodiments, the polymeric material comprises an aliphatic urethane (meth)acrylate. In some embodiments, the polymeric material comprises isobornyl (meth)acrylate, trimethylolpropane tri(meth)acrylate, 3,3,5-trimethcyclohexyl 2-((meth)acryloxy) benzoate, 3,3,5-Trimethylcyclohexyl (meth)acrylate, tripropylene glycol di(meth)acrylate, hexane-1,6-diol di(meth)acrylate, hydroxyethyl (meth)acrylate, benzyl (meth)acrylate, a derivative thereof, or a combination thereof. In some embodiments, the polymeric material comprises Dymax BRC-4421, Exothane 108, Exothane 10, isophorone urethane di(meth)acrylate (e.g., IPDI-UDMA), CN991, CN9782, CN3211, CN9782, CN9009, PU3201NT or a combination thereof.

Low levels of water absorption are favorable for polymeric materials described herein. Water absorption can occur when a polymeric material is exposed to a wet environment (e.g., a patient's mouth using an orthodontic appliance formed from a polymeric material). Properties of the polymeric material can degrade when water absorption reaches a threshold value, typically greater than 22 wt %. It is preferred herein that the polymeric materials have low levels of water uptake. In some embodiments, the polymeric material formed from the curable composition comprises a water uptake of less than 25 wt %, less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt %. In preferred embodiments, the polymeric material formed from the curable composition comprises a water uptake of less than 2 wt %. In more preferred embodiments, the polymeric material formed from the curable composition comprises a water uptake of less than 1 wt %. In even more preferred embodiments, the polymeric material formed from the curable composition comprises a water uptake of less than 0.5 wt %. In embodiments described herein, the water uptake is measured after 24 hours in a wet environment at 37° C. In some embodiments, a polymer formed from the oligomer of the resin is hydrophobic. In preferred embodiments, the polymeric material formed from the curable composition is hydrophobic.

In some embodiments, the polymeric material is characterized by having a low water uptake. In some embodiments, the polymeric material comprises less than 40 wt %, less than 35 wt %, less than 30 wt %, less than 25 wt %, less than 20 wt %, less than 15 wt %, less than 10 wt %, less than 5 wt %, less than 4 wt %, less than 3 wt %, less than 2 wt %, or less than 1 wt % water after 24 hours in a wet environment at 37° C. In preferred embodiments, the polymeric material comprises less than 2 wt % water after 24 hours in a wet environment at 37° C. In more preferred embodiments, the polymeric material comprises less than 1 wt % water after 24 hours in a wet environment at 37° C. In even more preferred embodiments, the polymeric material comprises less than 0.5 wt % water after 24 hours in a wet environment at 37° C.

The polymeric materials formed from the curable compositions can have high conversion rates, or high extent of reactions. In some embodiments, the polymeric material comprises 20-100 wt % of the polymer formed from the oligomer(s) and/or monomer(s) of the curable composition. In some embodiments, the polymeric material comprises greater than 20 wt %, greater than 30 wt %, greater than 40 wt %, greater than 50 wt %, greater than 60 wt %, greater than 70 wt %, greater than 80 wt %, greater than 85 wt %, greater than 90 wt %, greater than 95 wt %, greater than 98 wt %, or greater than 99 wt % of the polymer formed from the oligomer(s) and/or monomer(s) of the curable composition. In certain embodiments, it is preferable to have a high conversion percentage of oligomer(s) and/or monomer(s) into polymer when forming the polymeric material. In some embodiments, the formed polymer is hydrophobic.

In some embodiments, the polymeric materials formed from the curable compositions have high conversion rates of reactive group double bonds (e.g., acrylates or methacrylates) to single bonds, indicating incorporation into the polymeric material. In some embodiments, the conversion of reactive double bonds in the resin to single bonds in the polymeric material can be measured by FTIR (e.g., by measuring relative amounts before and after curing). In some embodiments, the polymeric material formed from the curable composition has greater than 60%, greater than 70%, greater than 80%, greater than 90%, or greater than 95% conversion of double bonds to single bonds.

In some embodiments, the polymeric materials formed from the curable compositions have low levels of extractable materials (e.g., unreacted monomers from said curable composition). The amount of extractable materials can be determined by weight loss of the polymeric material after soaking in water for 1 week, after soaking in ethanol for 48 hours, or after soaking in hexane for 48 hours. A general experiment for determining the amount of extractable material includes the steps of (i) weighing a dried sample of the polymeric material; (ii) soaking the sample in a solvent at a given temperature (e.g., 25° C.) for a period of time; (iii) refreshing the solvent until extraction is completed; (iv) drying the sample in an oven; (v) weighing the extracted sample; and (vi) calculating the weight loss. In some embodiments, the polymeric materials formed from the curable composition have less than 5 wt %, less than 4 wt %, less than 3 wt %, less than 2 wt %, less than 1 wt %, less than 0.75 wt %, less than 0.5 wt %, or less than 0.25 wt % extractable materials.

In some embodiments, the polymeric material has less than 20 wt %, less than 15 wt %, less than 10 wt %, less than 9 wt %, less than 8 wt %, less than 7 wt %, less than 6 wt %, less than 5 wt %, less than 4 wt %, less than 3 wt %, less than 2 wt %, or less than 1 wt % hydrogen bonding units, as calculated or measured by weight percentage of hydrogen bonding groups, further described herein. In preferred embodiments, the polymeric material has less than or equal to 10 wt % hydrogen bonding units.

In some cases, the polymeric material comprises a color defined by an L* value between 70 and 95, an a* value of between −11 and 1, and a b* value of between 2 and 22. In some cases, the polymeric material comprises a color defined by an L* value between 78 and 87, an a* value of between −7 and −3, and a b* value of between 8 and 16.

In some embodiments, the polymeric material is clear, substantially clear, mostly clear, or opaque. In certain embodiments, the polymeric material is clear. In certain embodiments, the polymeric material is substantially clear. In certain embodiments, the polymeric material is mostly clear. In some embodiments, greater than 70% of visible light passes through the polymeric material. In certain embodiments, greater than 80% of visible light passes through the polymeric material. In certain embodiments, greater than 90% of visible light passes through the polymeric material. In certain embodiments, greater than 95% of visible light passes through the polymeric material. In certain embodiments, greater than 99% of visible light passes through the polymeric material. Transparency can be measured using a UV-Vis spectrophotometer. In some embodiments, the transparency is measured by measuring the passage of a wavelength of transparency. In some embodiments, greater than 70%, greater than 80%, greater than 90%, greater than 95%, or greater than 99% of the wavelength of transparency can pass through the polymeric material. In some embodiments, the wavelength of transparency is in the visible light range (i.e., from 400 nm to 800 nm), is in the infrared light range, or is in the ultraviolet light range. In some embodiments, the polymeric material does not have color. In other embodiments, the polymeric material appears white, off-white, or mostly transparent with white coloring, as detected by the human eye.

In some embodiments, greater than 20%, greater than 30%, greater than 40%, greater than 50%, greater than 60%, greater than 70%, greater than 80%, greater than 90%, or greater than 95% of visible light passes through the polymeric material after 24 hours in a wet environment at 37° C. In preferred embodiments, greater than 70% of visible light passes through the polymeric material after 24 hours in a wet environment at 37° C.

In some embodiments, the polymeric material is biocompatible, bioinert, or a combination thereof.

In some embodiments, the polymeric material is formed using 3D printing (i.e., by additive manufacturing) using photopolymerization. In certain embodiments, the polymeric material is formed using conventional 3D printers. In some embodiments, the polymeric material can be used in coatings, molds, injection molding machines, or other manufacturing methods that use or could use light during the curing process. In some embodiments, the polymeric material is well suited for applications that require, e.g., solvent resistance, humidity resistance, water resistance, creep resistance, or heat deflection resistance.

### Methods of Making Polymeric Materials

The present disclosure provides methods for making the polymeric materials described herein, wherein said polymeric materials are formed by polymerizing (e.g., photocuring) the curable compositions comprising polymerization inhibitor-functionalized particles, a reactive diluent and a telechelic compound described herein, and optionally one or more additional compositions selected from initiators, T_{g} modifiers, crosslinking modifiers, solvents, fillers, antioxidants, pigments, colorants, surface modifiers, and mixtures thereof, to obtain an optionally cross-linked polymer. In some embodiments, the method for forming a polymeric material comprises: (i) providing a curable composition disclosed herein; (ii) removing the polymerization inhibitor-functionalized particles to provide a curable composition free of polymerization inhibitor-functionalized particle; and (iii) curing the curable composition that is free of polymerization inhibitor-functionalized particles, forming the polymeric material disclosed herein.

In some embodiments, providing the curable composition comprises mixing the components of the curable composition, including the polymerization inhibitor-functionalized particles, reactive diluent, and telechelic compound, etc.

In some embodiments, removing the polymerization inhibitor-functionalized particles comprises removing the particles from the curable composition by filtering or centrifuging.

In some embodiments, curing the curable composition that is free of polymerization inhibitor-functionalized particles comprises exposing the curable composition to a light source that initiates and/or facilitates photopolymerization. In some embodiments, a photoinitiator can be used as part of the curable composition to accelerate and/or initiate photopolymerization. In some embodiments, the curable composition is exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV) or visible. UV light sources include UVA (wavelength about 400 nanometers (nm) to about 320 nm), UVB (about 320 nm to about 290 nm), or UVC (about 290 nm to about 100 nm). Any suitable source may be used, including laser sources. The source may be broadband or narrowband, or a combination thereof. The light source may provide continuous or pulsed light during the process. Both the length of time the system is exposed to UV light and the intensity of the UV light can be varied to determine the ideal reaction conditions. In certain embodiments, a curable composition is cured using an additive manufacturing device to produce the polymeric material. In some embodiments, the curable composition herein may be heated to a pre-defined elevated process temperature ranging from about 50° C. to about 120° C., such as from about 90° C. to about 120° C., before becoming irradiated with light of a suitable wavelength to be absorbed by the photoinitiator, thereby causing activation of the photoinitiator to induce polymerization of the curable to obtain a cured polymeric material, which can optionally be crosslinked.

In some embodiments, the methods disclosed herein for forming a polymeric material are part of a high temperature lithography-based photopolymerization process, wherein a curable composition (e.g., a photocurable composition) that can comprise at least one photoinitiator is heated to an elevated process temperature. The heating may lower the viscosity of the curable composition before and/or during curing. Non-limiting examples of high-temperature lithography processes include those processes described in WO 2015/075094, WO 2016/078838, and WO 2018/032022. In some implementations, the high-temperature lithography may involve applying heat to material to temperatures from about 50° C. to about 120° C., such as from about 90° C. to about 120° C., from about 100° C. to about 120° C., from about 105° C. to about 115° C., from about 108° C. to about 110° C., etc. The material may be heated to temperatures greater than about 120° C. It is noted that other temperature ranges may be used without departing from the scope and substance of the inventive concepts described herein. Thus, a method for forming a polymeric material according to the present disclosure can offer the possibility of quickly and facilely producing devices, such as orthodontic appliances, by additive manufacturing such as 3D printing using curable composition as disclosed herein. In some embodiments, during the 3D printing process, the polymerization inhibitor-functionalized particles may be applied to the parts of a 3D printer that are exposed to the curable composition, thereby stabilizing the heated curable composition.

In some embodiments, the methods disclosed herein further comprise heating the polymeric material to an elevated temperature. In certain embodiments, the elevated temperature is from 40° C. to 150° C. In some embodiments, heating the polymeric material to the elevated temperature occurs after curing the curable composition. In certain embodiments, a thermal cure occurs by heating the polymeric material comprising a thermal initiator to an elevated temperature following the photo-curing step. In certain embodiments, the curable composition is cured using an additive manufacturing device to produce the polymeric material. In some embodiments, the additive manufacturing device is a 3-D printer. In some embodiments, the method further comprises the step of cleaning the polymeric material. In certain embodiments, the cleaning of the polymeric material includes washing and/or rinsing the polymeric material with a solvent, which can remove monomers and undesired impurities from the polymeric material.

As described herein, a polymeric material produced by the methods provided herein can be characterized by one or more of: (i) a storage modulus greater than or equal to 200 MPa; (ii) a flexural stress of greater than or equal to 1.5 MPa remaining after 24 hours in a wet environment at 37° C.; (iii) an elongation at break greater than or equal to 5% before and after 24 hours in a wet environment at 37° C.; (iv) a water uptake of less than 25 wt % when measured after 24 hours in a wet environment at 37° C.; and (v) transmission of at least 30% of visible light through the polymeric material after 24 hours in a wet environment at 37° C. In various cases, such polymeric material can be characterized by at least 2, 3, 4, or all of these properties.

### Fabrication and Use of 3D Printed Objects

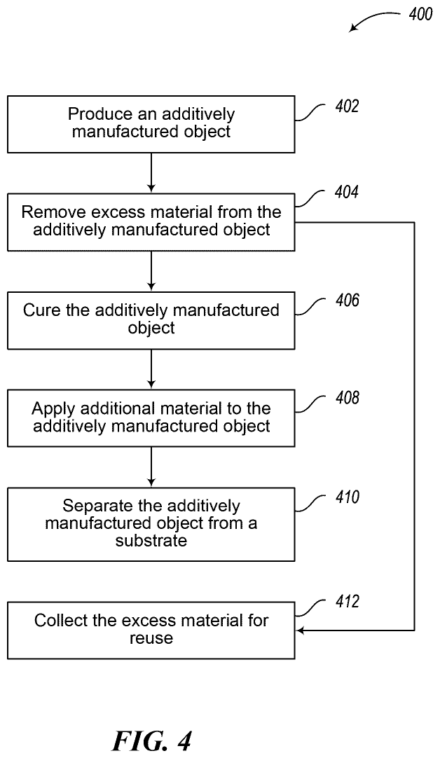

FIG. 4 is a flow diagram providing a general overview of a method 400 for fabricating and post-processing an additively manufactured object, in accordance with embodiments of the present disclosure. The method 400 can be used to produce many different types of additively manufactured objects, such as orthodontic appliances (e.g., aligners, palatal expanders, attachments, attachment templates, retainers), restorative objects (e.g., crowns, veneers, implants), and/or other dental appliances (e.g., oral sleep apnea appliances, mouth guards). Additional examples of orthodontic appliances and associated methods that are applicable to the present disclosure are described below.

The method 400 begins at operation 402 with producing an additively manufactured object. The additively manufactured object can be produced using any suitable additive manufacturing technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material (e.g., a photo-curable resin) onto a build platform. The precursor material can be cured, polymerized, melted, sintered, fused, and/or otherwise solidified to form a portion of the object and/or combine the portion with previously formed portions of the object. In some embodiments, the additive manufacturing techniques provided herein build up the object geometry in a layer-by-layer fashion, with successive layers being formed in discrete build steps. Alternatively, or in combination, the additive manufacturing techniques described herein can allow for continuous build-up of an object geometry.

Examples of additive manufacturing techniques suitable for use with the methods described herein include, but are not limited to, the following: (1) vat photopolymerization, in which an object is constructed from a vat of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer-by-layer, and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding.

For example, the additively manufactured object can be fabricated using a vat photopolymerization process in which light is used to selectively cure a vat or reservoir of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the vat, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 108° C. or 110° C. The heating can lower the viscosity of the photopolymerizable material before and/or during curing. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In a further example, the additively manufactured object can be fabricated using a selective laser sintering process involving using a laser beam to selectively melt and fuse a layer of powdered material according to a desired cross-sectional shape to build up the object geometry. As another example, the additively manufactured object can be fabricated using a fused deposition modeling process involving melting and selectively depositing a thin filament of thermoplastic polymer in a layer-by-layer manner to form an object. In yet another example, the additively manufactured object can be fabricated using a material jetting process involving jetting or extruding one or more materials onto a build surface to form successive layers of the object geometry.

In some embodiments, the additively manufactured object is fabricated using continuous liquid interphase production (also known as “continuous liquid interphase printing”) in which the object is continuously built up from a reservoir of photo-curable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path to form the object. Such methods are described in U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present disclosure include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting overlapping light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present disclosure are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources to fabricate an object from a plurality of different materials. Examples of such methods are described in U.S. Pat. Nos. 6,749,414 and 11,318,667, the disclosures of which are incorporated herein by reference in their entirety. Alternatively, or in combination, the additively manufactured object can be formed from multiple materials in a plurality of sequential manufacturing steps. For instance, a first portion of the object can be formed from a first material in accordance with any of the methods herein, then a second portion of the object can be formed from a second material in accordance with methods herein, and so on, until the entirety of the object has been formed.

After the additively manufactured object is fabricated, the object can undergo one or more additional process steps, also referred to herein as “post-processing.” As described in detail below with respect to operations 404-412, post-processing can include removing excess material from the object, applying additional material(s) to the object, performing additional curing, separating the object from any supports or other structures that are not intended to be present in the final product, and/or collecting the removed excess material for reuse.

For example, at operation 404, the method 400 continues with removing excess material from the additively manufactured object. The excess material can include uncured material (e.g., unpolymerized liquid resin) and/or other unwanted material (e.g., debris) that remains on the additively manufactured object after fabrication. For example, certain materials used in additive manufacturing (e.g., highly viscous polymeric resins used in high temperature lithography) may adhere to the surface of the additively manufactured object. Additionally, excess material may accumulate on or within certain object features, such as cavities, crevices, indentations, apertures, etc. Accordingly, the additively manufactured object may need to be cleaned before further processing and use.

The excess material can be removed in many ways. In some embodiments, for example, the excess material is removed by rotating the additively manufactured object to centrifugally separate the excess material from the surfaces of the object. The rotation can be performed using a suitable device or system (e.g., a centrifuge) including components for supporting and applying rotational force to the additively manufactured object. Alternatively or in combination, the excess material can be removed by spraying or otherwise applying fluids (e.g., water, solvents) to the object, partially or fully immersing the object in a fluid, blowing a gas (e.g., air) on the object, applying a vacuum to the object, applying other types of mechanical forces to the object (e.g., vibration, agitation, tumbling, brushing), and/or other cleaning techniques known to those of skill in the art.

At operation 406, the method 400 can optionally include curing the additively manufactured object. This additional curing step (also known as “post-curing”) can be used in situations where the additively manufactured object is still in a partially cured “green” state after fabrication. For example, the curing energy used to fabricate the additively manufactured object at operation 402 may only partially polymerize the resin forming the object. Accordingly, the post-curing step may be needed to fully cure (e.g., fully polymerize) the additively manufactured object to its final, usable state. Post-curing can provide various benefits, such as improving the mechanical properties (e.g., stiffness, strength) and/or temperature stability of the additively manufactured object. Post-curing can be performed by heating the object, applying radiation (e.g., ultraviolet (UV), visible, microwave) to the object, or suitable combinations thereof. Post-curing can be performed by a specialized device (e.g., an oven or curing station) or can be performed by the same device used to rotate the additively manufactured object at operation 404. In other embodiments, however, the post-curing process of operation 406 is optional and can be omitted.

At operation 408, the method 400 can optionally include applying an additional material to the additively manufactured object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., an orthodontic appliance worn on the teeth); coloring and/or applying other aesthetic features to the object; improving scratch resistance and/or other mechanical properties; providing antimicrobial properties; and incorporating therapeutic agents into the object for controlled release.

At operation 410, the method 400 can include separating the additively manufactured object from a substrate. In some embodiments, the substrate is a build platform that mechanically supports the object during fabrication and the post-processing steps described herein. The additively manufactured object can be connected to the substrate via a sacrificial region of cured material. Accordingly, the additively manufactured object can be detached from the substrate by applying pressure to fracture the sacrificial region. Once separated, the additively manufactured object can then be prepared for packaging, shipment, and use.

At operation 412, the method 400 can optionally include collecting the excess material removed from the additively manufactured object at operation 404. The excess material can include uncured material that is still suitable for reuse in subsequent additive manufacturing processes (e.g., the fabrication process of operation 402). Accordingly, operation 412 can include collecting the excess material (e.g., via containers, absorbent elements, piping, etc.) and, optionally, separating reusable excess material from other unwanted components that may be present (e.g., water, solvents, debris) via filtration, distillation, centrifugation, and/or other suitable techniques.

The method 400 can be modified in many ways. For example, although the above steps of the method 400 are described with respect to a single additively manufactured object, the method 400 can be used to concurrently fabricate and post-process any suitable number of additively manufactured objects, such as tens, hundreds, or thousands of additively manufactured objects. As another example, the ordering of the steps shown in FIG. 4 can be varied, e.g., the material application process of operation 408 can be performed before the curing process of operation 406. Some of the steps of the method 400 can be omitted, such as any of operations 406, 408, and/or 412. The method 400 can also include additional steps not shown in FIG. 4.

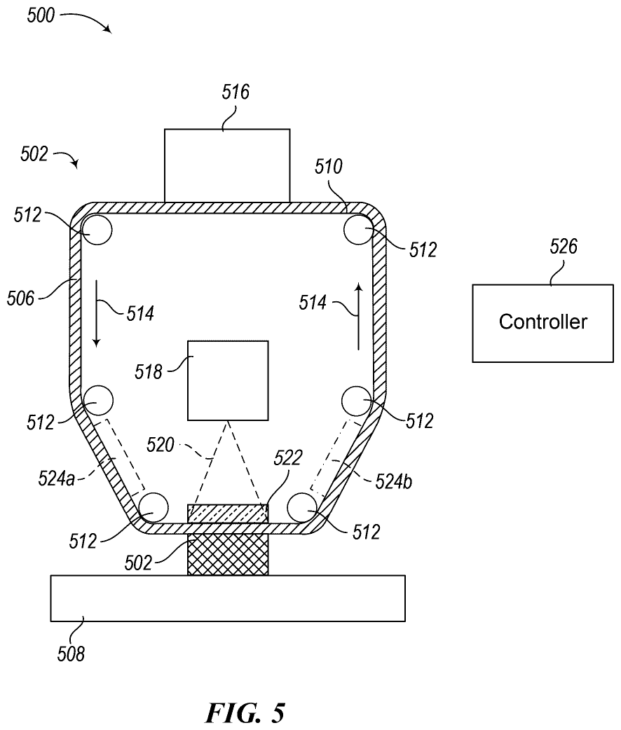

FIG. 5 illustrates a representative example of an additive manufacturing device 500 (“device 500”) configured in accordance with embodiments of the present disclosure. The device 500 can be used to fabricate any embodiment of the additively manufactured objects described herein. For example, the device 500 can be used to produce an additively manufactured object in accordance with operation 402 of the method 400 of FIG. 4.

As shown in FIG. 5, the device 500 is used to fabricate an additively manufactured object 502 (“object 502”). The device 500 includes a printer assembly 504 configured to deposit resin 506 on a build platform 508 (e.g., a tray, plate, film, sheet, or other planar substrate) to form the object 502. The printer assembly 504 includes a carrier film 510 configured to deliver the resin 506 to the build platform 508. The carrier film 510 can be a flexible loop of material having an outer surface and an inner surface. The outer surface of the carrier film 510 can adhere to and carry a thin layer of the resin 506. The inner surface of the carrier film 510 can contact one or more rollers 512 that rotate to move the carrier film 510 in a continuous loop trajectory, e.g., as indicated by arrows 514.

The printer assembly 504 can also include a resin source 516 (shown schematically) configured to apply the resin 506 to the carrier film 510. In the illustrated embodiment, the resin source 516 is located at the upper portion of the printer assembly 504 near an upper horizontal segment of the carrier film 510. In other embodiments, however, the resin source 516 can be positioned at a different location in the printer assembly 504. The resin source 516 can include nozzles, ports, reservoirs, etc., that deposit the resin 506 onto the outer surface of the carrier film 510. The resin source 516 can also include one or more blades (e.g., doctor blades, recoater blades) that smooth the deposited resin 506 into a relatively thin, uniform layer. In some embodiments, the resin 506 is formed into a layer having a thickness within a range from 200 microns to 300 microns.

The resin 506 can be carried by the carrier film 510 toward the build platform 508. In the illustrated embodiment, the build platform 508 is located below the printer assembly 504 near a lower horizontal segment of the carrier film 510. In other embodiments, however, the build platform 508 can be positioned at a different location relative to the printer assembly 504. The printer assembly 504 includes a light source 518 (e.g., a projector or light engine) that outputs light 520 (e.g., UV light) having a wavelength configured to cure the resin partially or fully 506. The carrier film 510 can be optically transparent so that the light 520 from the light source 518 passes through the carrier film 510 and onto the portion of the resin 506 above the build platform 508, thus forming a layer of cured resin 506 onto the build platform 508 and/or a previously formed portion of the object 502. The light 520 can be patterned or scanned in a suitable pattern corresponding to the desired cross-section geometry for the object 502. Optionally, a transparent plate 522 can be disposed between the light source 518 and the carrier film 510 to guide the carrier film 510 into a specific position (e.g., height) relative to the build platform 508.

Once the object cross-section has been formed, the build platform 508 can be lowered by a predetermined amount to separate the cured resin from the carrier film 510. The remaining, uncured resin 506 can be carried by the carrier film 510 away from the build platform 508 and back toward the resin source 516. The resin source 516 can deposit additional resin 506 onto the carrier film 510 and/or smooth the resin 506 to re-form a uniform layer of resin 506 on the carrier film 510. The resin 506 can then be recirculated back to the build platform 508 to fabricate an additional layer of the object 502. This process can be repeated to iteratively build up individual object layers on the build platform 508 until the object 502 is complete. The object 502 and build platform 508 can then be removed from the device 500 for post-processing.

In some embodiments, the device 500 is used in a high temperature lithography process utilizing a highly viscous resin. Accordingly, the printer assembly 504 can include one or more heat sources (heating plates, infrared lamps, etc.) for heating the resin 506 to lower the viscosity to a range suitable for additive manufacturing. For example, the printer assembly 504 can include a first heat source 524a positioned against the segment of the carrier film 510 before the build platform 508, and a second heat source 524b positioned against the segment of the carrier film 510 after the build platform 508. Alternatively, or in combination, the printer assembly 504 can include heat sources at other locations.

The device 500 also includes a controller 526 (shown schematically) that is operably coupled to the printer assembly 504 and build platform 508 to control the operation thereof. The controller 526 can be or include a computing device including one or more processors and memory storing instructions for performing the additive manufacturing operations described herein. For example, the controller 526 can receive a digital 3D model of the object 502 to be fabricated, determine a plurality of object cross-sections to build up the object 502 from the resin 506, and can transmit instructions to the light source 518 to output light 520 to form the object cross-sections. As another example, the controller 526 can also determine and control other operational parameters, such as the positioning of the build platform 508 (e.g., height) relative to the carrier film 510, the movement speed and direction of the carrier film 510, the amount of resin 506 deposited by the resin 506, the thickness of the resin layer on the carrier film 510, and/or the amount of heating applied to the resin 506.

Although FIG. 5 illustrates a representative example of an additive manufacturing device, this is not intended to be limiting, and the embodiments described herein can be used in combination with other types of additive manufacturing devices (e.g., vat-based systems) and/or other types of additive manufacturing processes (e.g., material jetting, binder jetting, FDM, powder bed fusion, sheet lamination, directed energy deposition).

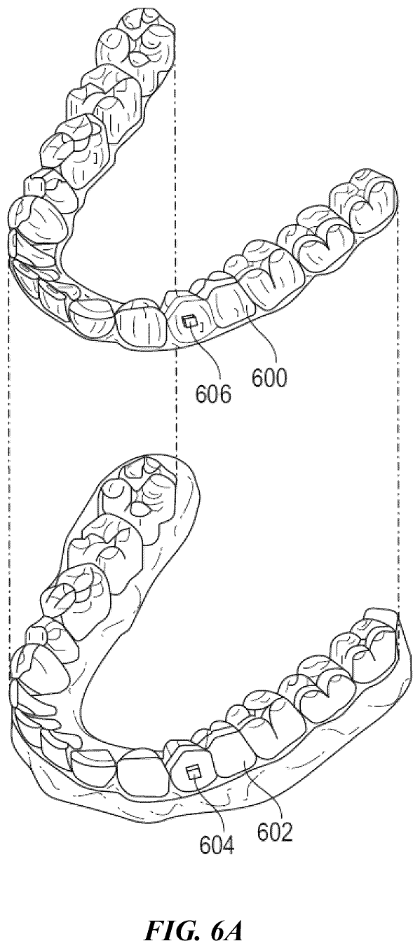

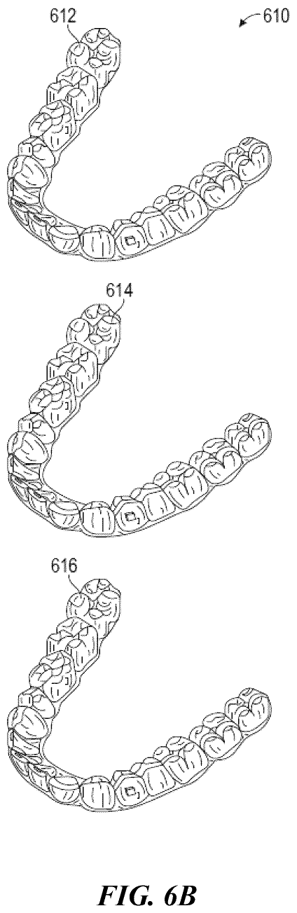

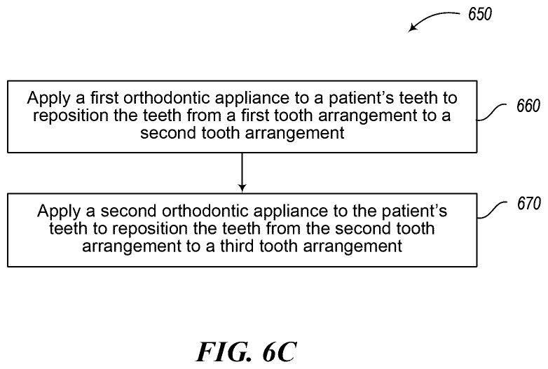

FIG. 6A illustrates a representative example of a tooth repositioning appliance 600 configured in accordance with embodiments of the present disclosure. The appliance 600 can be manufactured and post-processed using any of the systems, methods, and devices described herein. The appliance 600 (also referred to herein as an “aligner”) can be worn by a patient to achieve an incremental repositioning of individual teeth 602 in the jaw. The appliance 600 can include a shell (e.g., a continuous polymeric shell or a segmented shell) having teeth-receiving cavities that receive and resiliently reposition the teeth. The appliance 600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. In some embodiments, direct fabrication involves forming an object (e.g., an appliance or a portion thereof) without using a physical template (e.g., mold, mask, etc.) to define the object geometry. Though the discussion herein refers to “aligners,” any or all the discussion herein can refer to clear retainers used to retain a person's dentition at a target, final, intermediate, etc. stage of a treatment plan.

The appliance 600 can fit over all teeth present in an upper or lower jaw, or less than all the teeth. The appliance 600 can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance 600 can be a generic appliance configured to receive the teeth, but not necessarily shaped to match the topography of the patient's teeth. In some cases, only certain teeth received by the appliance 600 are repositioned by the appliance 600 while other teeth can provide a base or anchor region for holding the appliance 600 in place as it applies force against the tooth or teeth targeted for repositioning. In some cases, some, most, or even all the teeth can be repositioned at some point during treatment. Teeth that are moved can also serve as a base or anchor for holding the appliance as it is worn by the patient. In preferred embodiments, no wires or other means are provided for holding the appliance 600 in place over the teeth. In some cases, however, it may be desirable or necessary to provide individual attachments 604 or other anchoring elements on teeth 602 with corresponding receptacles 606 or apertures in the appliance 600 so that the appliance 600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 6B illustrates a tooth repositioning system 610 including a plurality of appliances 612, 614, 616, in accordance with embodiments of the present disclosure. Any of the appliances described herein can be designed and/or provided as part of a set of a plurality of appliances used in a tooth repositioning system. Each appliance may be configured so that a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 610 can include a first appliance 612 corresponding to an initial tooth arrangement, one or more intermediate appliances 614 corresponding to one or more intermediate arrangements, and a final appliance 616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 6C illustrates a method 650 of orthodontic treatment using a plurality of appliances, in accordance with embodiments of the present disclosure. The method 650 can be practiced using any of the appliances or appliance sets described herein. At operation 660, a first orthodontic appliance is applied to a patient's teeth to reposition the teeth from a first tooth arrangement to a second tooth arrangement. At operation 670, a second orthodontic appliance is applied to the patient's teeth to reposition the teeth from the second tooth arrangement to a third tooth arrangement. The method 650 can be repeated as necessary using any suitable number and combination of sequential appliances to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied to compensate for any inaccuracies or limitations of the appliance.

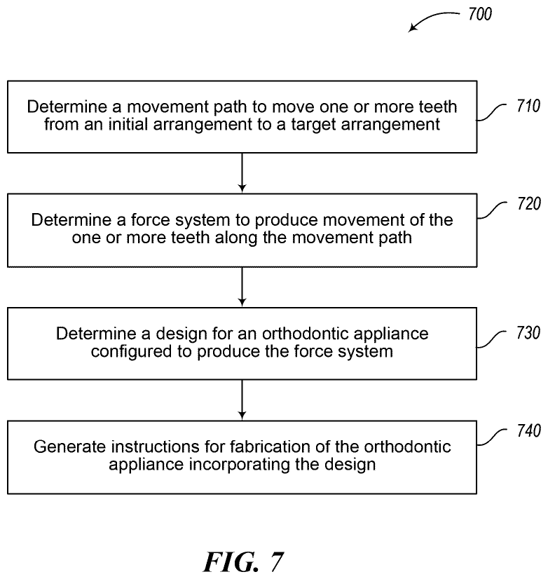

FIG. 7 illustrates a method 700 for designing an orthodontic appliance, in accordance with embodiments of the present disclosure. The method 700 can be applied to any embodiment of the orthodontic appliances described herein. Some or all the steps of the method 700 can be performed by any suitable data processing system or device, e.g., one or more processors configured with suitable instructions.

At operation 710, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

At operation 720, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully formed suture. Thus, in juvenile patients and others without fully closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

At operation 730, a design for an orthodontic appliance configured to produce the force system is determined. The design can include the appliance geometry, material composition, and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, Calif. For creating finite element models and analyzing them, program products from several vendors can be used, including finite element analysis packages from ANSYS, Inc., of Canonsburg, Pa., and SIMULIA (Abaqus) software products from Dassault Systemes of Waltham, Mass.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

At operation 740, instructions for fabrication of the orthodontic appliance incorporating the design are generated. The instructions can be configured to control a fabrication system or device to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 700 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 700 may be performed with any suitable fabrication system or device, such as the embodiments described herein. Some of the steps may be optional, and the order of the steps can be varied as desired.

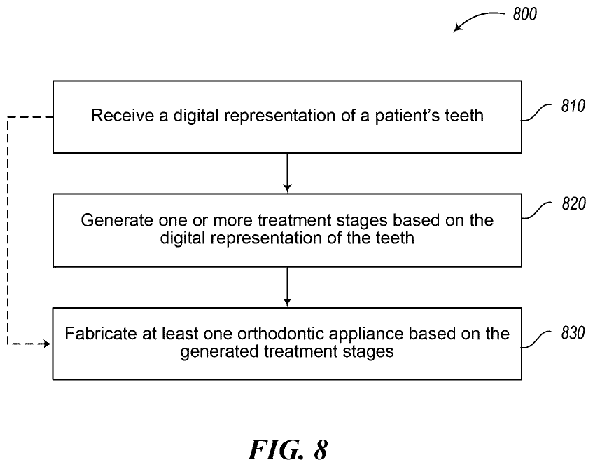

FIG. 8 illustrates a method 800 for digitally planning an orthodontic treatment and/or design or fabrication of an appliance, in accordance with embodiments. The method 800 can be applied to any of the treatment procedures described herein and can be performed by any suitable data processing system.

At operation 810, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

At operation 820, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

At operation 830, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 8, design and/or fabrication of an orthodontic appliance, and perhaps a particular orthodontic treatment, may include use of a representation of the patient's teeth (e.g., including receiving a digital representation of the patient's teeth (operation 810)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment fabrication templates, e.g., appliances used to position prefabricated attachments on a person's teeth in accordance with one or more aspects of a treatment plan. Examples of attachment fabrication templates can be found at least in: U.S. application Ser. No. 17/249,218, entitled, “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled, “Dental Attachment Placement Structure,” filed Jun. 14, 2017; U.S. application Ser. No. 14/963,527, entitled, “Dental Attachment Placement Structure,” filed Dec. 9, 2015; U.S. application Ser. No. 14/939,246, entitled, “Dental Attachment Placement Structure,” filed Nov. 12, 2015; U.S. application Ser. No. 14/939,252, entitled, “Dental Attachment Formation Structures,” filed Nov. 12, 2015; and U.S. Pat. No. 9,700,385, entitled, “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Experimental Methods

All chemicals were purchased from commercial sources and were used without further purification, unless otherwise stated.

In some embodiments, the stress relaxation of a material or device can be measured by monitoring the time-dependent stress resulting from a steady strain. The extent of stress relaxation can also depend on the temperature, relative humidity, and other applicable conditions (e.g., presence of water). In embodiments, the test conditions for stress relaxation are a temperature of 37±2° C. at 100% relative humidity or a temperature of 37±2° C. in water.

The dynamic viscosity of a fluid indicates its resistance to shearing flows. The SI unit for dynamic viscosity is the Poiseuille (Pa·s). Dynamic viscosity is commonly given in units of centipoise, where 1 centipoise (cP) is equivalent to 1 mPa·s. Kinematic viscosity is the ratio of the dynamic viscosity to the density of the fluid; the SI unit is m²/s. Devices for measuring viscosity include viscometers and rheometers. For example, an MCR 301 rheometer from Anton Paar may be used for rheological measurement in rotation mode (PP-25, 50 s-1, 50-115° C., 3° C./min).

Determining the water content when fully saturated at use temperature can comprise exposing the polymeric material to 100% humidity at the use temperature (e.g., 40° C.) for a period of 24 hours, then determining water content by methods known in the art, such as by weight.

In some embodiments, the presence of a crystalline phase and an amorphous phase provides favorable material properties to the polymeric materials. Property values of the cured polymeric materials can be determined, for example, by using the following methods:
stress relaxation properties can be assessed using an RSA-G2 instrument from TA Instruments, with a 3-point bending, according to ASTM D790; for example, stress relaxation can be measured at 30° C. and submerged in water, and reported as the remaining load after 24 hours, as either the percent (%) of initial load, and/or in MPa;
storage modulus can be measured at 37° C. and is reported in MPa;
T_{g} of the cured polymeric material can be assessed using dynamic mechanical analysis (DMA) and is provided herein as the tan δ peak;
tensile modulus, tensile strength, elongation at yield, and elongation at break can be assessed according to ISO 527-2 5B; and tensile strength at yield, elongation at break, tensile strength, and Young's modulus can be assessed according to ASTM D1708.

Additive manufacturing or 3D printing processes for generating a device herein (e.g., an orthodontic appliance) can be conducted using a device of FIG. 5. In such cases, a photopolymerizable composition (e.g., resin) according to the present disclosure can be heated to 90-110° C. The building platform can be heated to 90-110° C., too, and lowered to establish holohedral contact with the upper surface of the polymerizable composition. By irradiating the composition with 375 nm UV radiation using a diode laser from Soliton, which can have an output power of 70 mW, which can be controlled to trace a predefined prototype design, and alternately raising the building platform, the composition can be cured layer by layer by a photopolymerization process according to the disclosure, resulting in a polymeric material according to present disclosure.

### EXAMPLES

The specific compositions, synthesis, formulations, and descriptions of any of the materials, devices, systems, and components thereof, of the present disclosure can be readily varied depending upon the intended application, as will be apparent to those of skill in the art in view of the disclosure herein. Moreover, it is understood that the examples and aspects described herein are for illustrative purposes only and that various modifications or changes in light thereof can be suggested to persons skilled in the art and are included within the spirit and purview of this application and scope of the appended claims. Numerous different combinations of aspects described herein are possible, and such combinations are considered part of the present disclosure. In addition, all features discussed in connection with any one aspect herein can be readily adapted for use in other aspects herein. The use of different terms or reference numerals for similar features in different aspects does not necessarily imply differences other than those expressly set forth. Accordingly, the present disclosure is intended to be described solely by reference to the appended claims, and not limited to the aspects disclosed herein.

### Example 1

### Preparation of BHT-Functionalized Polystyrene (PS) Particles

Polystyrene (PS) particles were surface functionalized with —OH groups via a H₂O plasma or piranha solution treatment. The carboxyl surface functional group on the PS particles was subsequently reacted with the hydroxy group in the hydroxyl-substituted BHT via an ester forming condensation reaction.

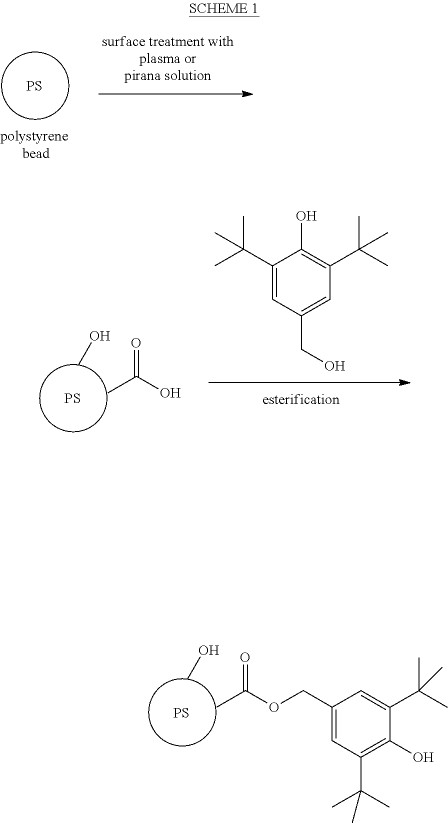

### Example 2

### Preparation of BHT-Functionalized Silica Particles

Silica particles were surface modified by (2-mercaptoethyl)silanetriol. The thiol (—SH) group in the surface modified particles was subsequently reacted with the vinyl group in the vinyl-substituted BHT via a thiol-ene reaction.

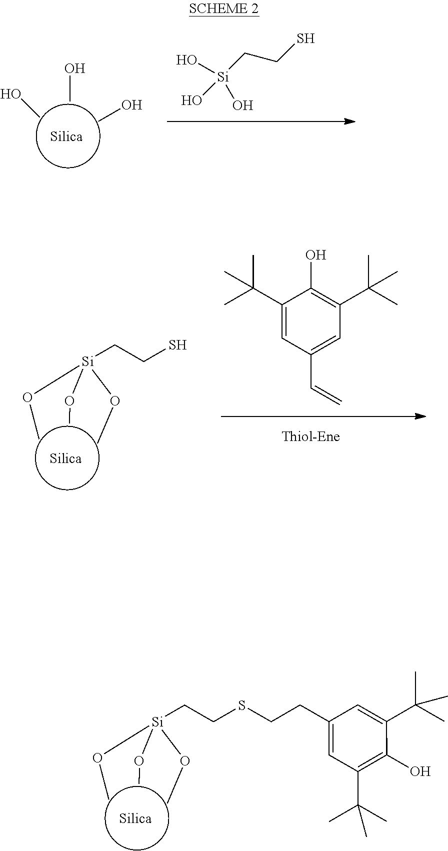

### Example 3

### Preparation of BHT-Functionalized Silica Particles

Silica particles were surface modified by 2-(oxiran-2-yl)ethyl)silanetriol. The epoxy group in the surface modified particles was subsequently reacted with the carboxyl group in the carboxyl-substituted BHT via an ester forming condensation reaction.

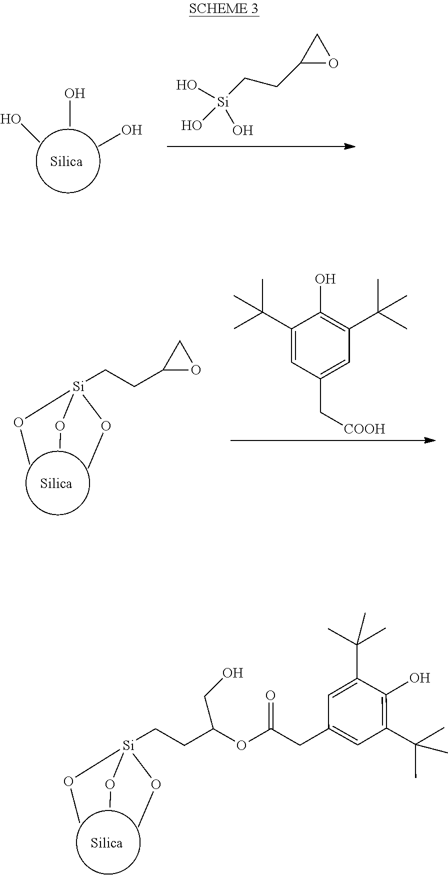

### Example 4

### Preparation of BHT-Functionalized Polystyrene Particles

Polystyrene (PS) particles were surface functionalized with —OH groups via H₂O plasma treatment or piranha solution treatment. The PS particles were subsequently surface modified by divinyl sulphone (DVS). The vinyl group in the surface modified PS particles was then reacted with the thiol (—SH) group in the thiol-substituted BHT via a thiol-ene reaction.

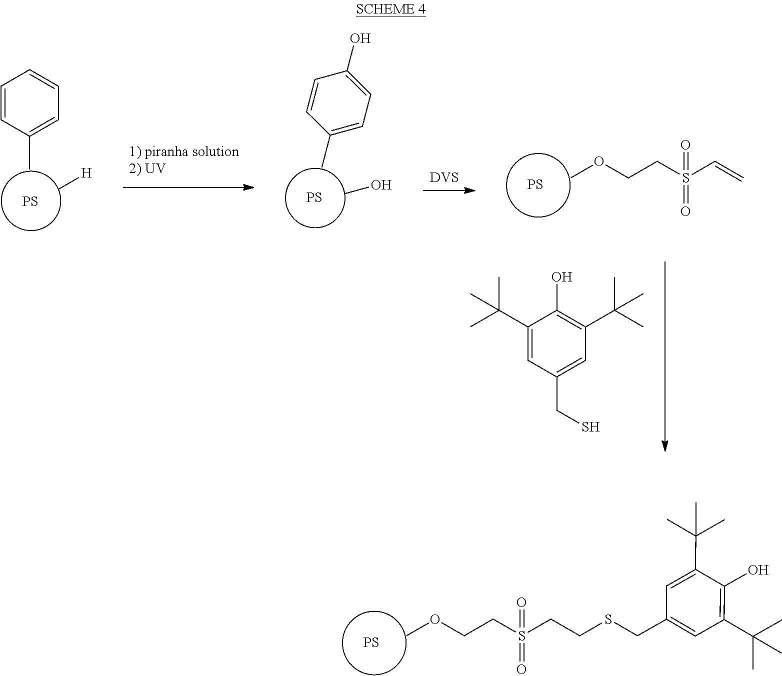

### Example 5

### Preparation of BHT-Functionalized Copolymer Particles

Particles made of copolymer containing reactive groups at the polymer side chain were prepared by copolymerizing methacrylic acid and styrene monomer. The carboxyl group on the polymer side chain was subsequently reacted with the hydroxy group in the hydroxyl-substituted BHT via an ester forming condensation reaction.

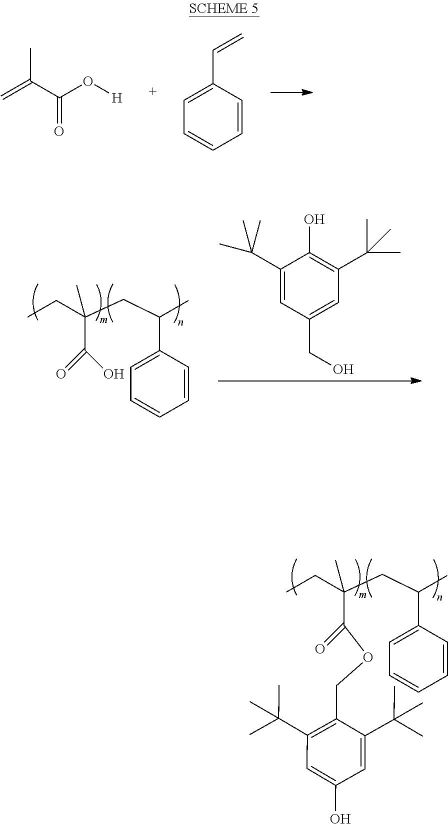

### Example 6

### Treatment Using an Orthodontic Appliance

This example describes the use of a directly 3D printed orthodontic appliance to move a patient's teeth according to a treatment plan. This example also describes the characteristics that the orthodontic appliance can have following its use, in contrast to its characteristics prior to use.

A patient in need of, or desirous of, a therapeutic treatment to rearrange at least one tooth has their teeth arrangement assessed. An orthodontic treatment plan is generated for the patient. The orthodontic treatment plan comprises a plurality of intermediate tooth arrangements for moving teeth along a treatment path, from the initial arrangement (e.g., that which was initially assessed) toward a final arrangement. The treatment plan includes the use of an orthodontic appliance, fabricated using curable compositions and methods disclosed further herein, to provide orthodontic appliances having low levels of hydrogen bonding units. In some embodiments, a plurality of orthodontic appliances are used, each of which can be fabricated using the curable compositions and methods disclosed further herein.

The orthodontic appliances are provided, and iteratively applied to the patient's teeth to move the teeth through each of the intermediate tooth arrangements toward the final arrangement. The patient's tooth movement is tracked. A comparison is made between the patient's actual teeth arrangement and the planned intermediate arrangement. Where the patient's teeth are determined to be tracking according to the treatment plan, but have not yet reached the final arrangement, the next set of appliances can be administered to the patient. The threshold difference values of a planned position of teeth to actual positions selected as indicating that a patient's teeth have progressed on-track are provided above in Table 1. If a patient's teeth have progressed at or within the threshold values, the progress is considered to be on-track. Favorably, the use of the appliances disclosed herein increases the probability of on-track tooth movement.

TABLE 1

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The assessment and determination of whether treatment is on-track can be conducted, for example, 1 week (7 days) following the initial application of an orthodontic appliance. Following this period of application, additional parameters relating to assessing the durability of the orthodontic appliance can also be conducted. For example, relative repositioning force (compared to that which was initially provided by the appliance), remaining flexural stress, relative flexural modulus, and relative elongation at break can be determined.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A surface functionalized particle, comprising:
a particle having a surface; and
a plurality of polymerization inhibitor moieties each covalently bonded to the surface of the particle via a linker.

2. The surface functionalized particle of claim 1, wherein the particle is an inorganic particle, a polymeric particle, or an inorganic-organic hybrid particle.

3. The surface functionalized particle of claim 2, wherein the inorganic material in the particle comprises silicon dioxide (silica), aluminum oxide (alumina), titanium dioxide, zinc oxide, zirconium dioxide, cerium dioxide, manganese dioxide, iron oxide, calcium oxide, glass or quartz.

4. The surface functionalized particle of claim 2, wherein the organic material in the particle comprises polyamide, polystyrene (PS), polybutadiene, polyethylene, polypropylene, polyvinyl alcohol, polyvinyl ether, polyvinyl ester, polyvinyl halides such as poly(vinyl chloride), polyvinylpyrrolidone, polysiloxane, poly(vinyl acetate) or a copolymer thereof.

5. The surface functionalized particle of claim 2, wherein the particle comprises a copolymer having the following structure (I): 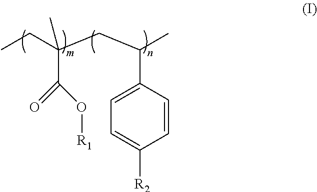
wherein:
R₁ is, at each occurrence, independently, H, alkyl, cycloalkyl, aryl or heteroaryl;
R₂ is, at each occurrence, independently, H, OH, alkyl or alkoxy; and
m and n are each an integer of one or greater,
provided that the copolymer contains at least one carboxyl or hydroxyl group.

6. The surface functionalized particle of claim 5, wherein the copolymer of structure (I) has the following structure:

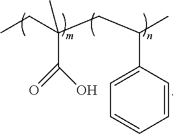

7. The surface functionalized particle of claim 1, wherein the polymerization inhibitor moieties comprise a monovalent of:
phenothiazine, butylated hydroxytoluene (BHT), 4-methoxyphenol (MEHQ), 2,2,6,6-tetramethylpiperidinyloxy (TEMPO), Irganox 565 (2,6-di-tert-butyl-4-(4,6-bis(octylthio)-1,3,5-triazin-2-ylamino)phenol), Irganox 1010 (pentaerythritol tetrakis(3-(3,5-di-tert-butyl-4-hydroxyphenyl)propionate), Irganox MD 1024 (2′,3-bis((3-(3,5-di-tert-butyl-4-hydroxyphenyl)propionyl))propionohydrazide), Irganox 1035 (thiodiethylene bis(3-(3,5-di-tert-butyl-4-hydroxy-phenyl)propionate)), Irganox 1726 (2,4-bis(dodecylthiomethyl)-6-methylphenol), Irgafos 168 (tris(2,4-di-tert-butylphenyl)phosphite), Irgafos 126 (bis(2,4-di-tert-butylphenol) pentaerythritol diphosphate), Revonox 420V (bis(alkyl hydrogenated palm-oil) hydroxy amines), Revonox 501 (multi-functional benzofuranone-based antioxidant), Revonox 608 (bis (2,4-dicumylphenyl) pentaerythritol diphosphate), vitamin E (α-tocopherol), 3-methyl-2-nitrobenzyl alcohol or 2-nitrobenzyl alcohol.

8. The surface functionalized particle of claim 7, wherein the polymerization inhibitor moieties comprise a monovalent of BHT or TEMPO.

9. The surface functionalized particle of claim 1, wherein the linker comprises one or more of O, N, S or Si atoms.

10. The surface functionalized particle of claim 9, wherein the linker has one of the following structures:

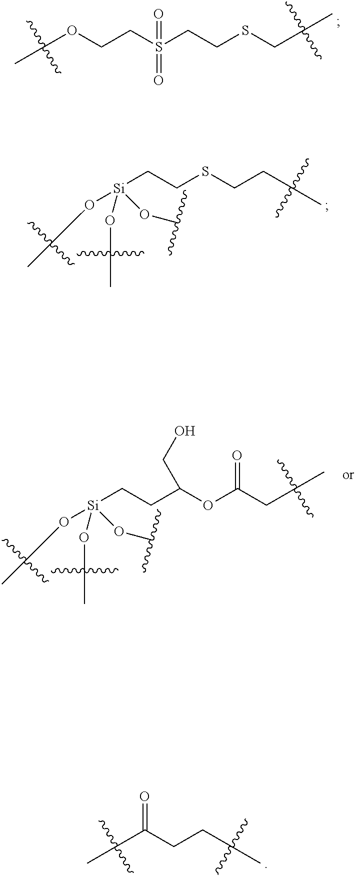 [SMILES: *CSCCS(=O)(=O)CCO* ; *CCSCC[Si](O*)(O*)O* ; *CC(=O)OC(CO)CC[Si](O*)(O*)O* ; *CCC(*)=O]

11. A curable composition, comprising:
a plurality of surface functionalized particles of claim 1;
a reactive diluent, wherein the reactive diluent is a polymerizable compound having a molecular weight of 0.1 to 1.0 kDa; and
a telechelic compound comprising:
an oligomeric or a polymeric chain of interconnected monomeric units having a first terminal end and a second terminal end, wherein the oligomeric or polymeric chain is selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ether, (poly)ester and (poly)urethane;
at least one first reactive functional group covalently bonded to the first terminal end; and
at least one second reactive functional group covalently bonded to the second terminal end.

12. The composition of claim 11, wherein the curable composition comprises the polymerization inhibitor in an amount ranging from 1 wt % to 10 wt %, based on a total amount of the curable composition.

13. The composition of claim 11, wherein the at least one first reactive functional group and the at least one second reactive group are independently selected from the group consisting of an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide and a styrenyl.

14. The composition of claim 11, wherein the at least one first reactive functional group and the at least one second reactive functional group independently have one of the following structures:

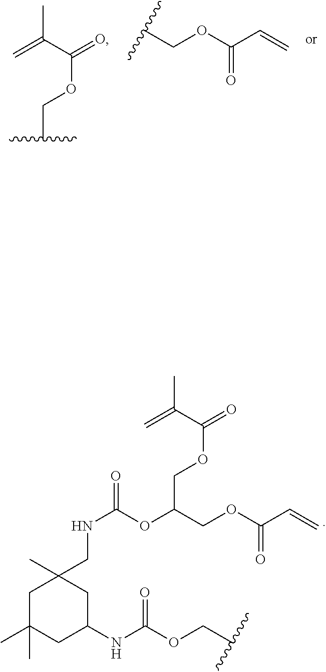

15. (canceled)

16. The composition of claim 11, wherein the telechelic compound has the following structure: 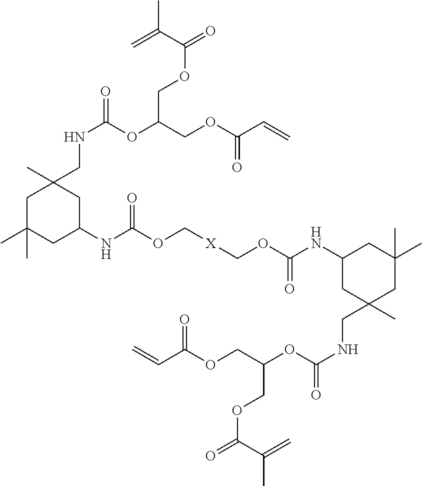
wherein:
X is an oligomeric or polymeric chain of interconnected monomeric units selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ether, (poly)ester and (poly)urethane.

17.-18. (canceled)

19. The composition of claim 11, wherein the reactive diluent comprises triethylene glycol dimethacrylate (TEGDMA), decanediol-1,10-dimethacrylate (D3MA), 1,12-dodecanediol dimethacrylate (D4MA), 3,3,5-trimethylcyclohexyl 2-(methacryloxy)benzoate (HSMA), benzyl salicylate methacrylate (BSMA), bisphenol A-glycidyl methacrylate (BisGMA) and urethane dimethacrylate (UDMA), 2-hydroxyethyl methacrylate (HEMA), 2-hydroxybutyl methacrylate (HBMA), isobornyl methacrylate (IBMA), 2-ethylhexyl methacrylate (EHMA), 2-cyanoethyl methacrylate (CEMA), benzyl methacrylate (BMA), 2-phenoxyethyl methacrylate (PEMA), butyl methacrylate (BMA), lauryl methacrylate (LMA), syringyl methacrylate (SMA) or combinations thereof.

20.-38. (canceled)

39. A polymeric material formed from the curable composition of claim 11.

40.-59. (canceled)

60. A 3D printed object comprising the polymeric material of claim 39.

61.-65. (canceled)

66. A method of forming a 3D printed object, the method comprising:
providing the curable composition of claim 11;
removing the plurality of surface functionalized particles from the curable composition;
curing the curable composition to form a polymeric material; and
fabricating the 3D printed object with the polymeric material.

67.-89. (canceled)

90. A method for preparing a surface functionalized particle comprising a plurality of polymerization inhibitor moieties thereon, comprising:
conducting a surface treatment to form a plurality of surface functional groups on a surface of the particle;
covalently bonding a surface functionalization compound having a first reactive group on one end of the compound and a second reactive group on an opposite end of the compound to the surface of the particle by reacting the first reactive group with one surface functional group of the plurality of surface functional groups; and
covalently bonding a reactive polymerization compound having a third reactive group to the surface functionalization compound by reacting the third reactive group and the second reactive group.

91.-99. (canceled)
